(19) United States
(12) Patent Application Publication
(10) Pub. No.: US 2026/0275014 A1
(43) Pub. Date: Sep. 17, 2026

(54) AQUEOUS POLYMER LATEX OF FILM-FORMING COPOLYMERS SUITABLE AS BINDER IN WATERBORNE COATING COMPOSITIONS

(71) Applicant: BASE SE, Ludwigshafen am Rhein (DE)

(72) Inventors: Friederike FLEISCHHAKER, Ludwigshafen am Rhein (DE); Christoph FLECKENSTEIN, Ludwigshafen am Rhein (DE); Andrea MISSKE, Ludwigshafen am Rhein (DE); Srividhya SUNDARAM, Ludwigshafen am Rhein (DE); David Martin MAURER, Ludwigshafen am Rhein (DE); Gunther ZIMMERMANN, Ludwigshafen am Rhein (DE)

(21) Appl. No.: 19/167,910

(22) PCT Filed: Mar. 21, 2024
(86) PCT No.: PCT/EP2024/057595

§ 371 Date: Sep. 23, 2025

(30) Foreign Application Priority Data
Mar. 24, 2023 (EP) 23164123.4
Dec. 6, 2023 (EP) 23214684.5

(51) Int. Cl. C08F 220/18; C08F 2/30; C08K 3/22; C08K 3/34; C08K 5/17; C08L 25/14; C08L 59/00; C08L 75/04; C09D 5/02; C09D 7/20; C09D 7/44; C09D 7/61; C09D 7/63; C09D 7/65; C09D 137/00

(52) U.S. Cl. CPC C08F 220/1804; C08F 2/30; C08K 3/346; C08K 5/17; C08L 25/14; C08L 59/00; C08L 75/04; C09D 5/025; C09D 5/028; C09D 7/20; C09D 7/44; C09D 7/61; C09D 7/63; C09D 7/65; C09D 137/00; C08K 2003/2241

(57) ABSTRACT

The present invention relates to aqueous polymer latices of film-forming copolymers obtainable by aqueous emulsion polymerisation of ethylenically unsaturated monomers M which comprise a combination of a methylene-γ-butyrolactone and (meth)acrylate esters. The present invention also relates to a process for producing such polymer latices and to the use of these polymer latices as binders in waterborne coating compositions. Furthermore, the present invention relates to a waterborne coating composition which contains a binder polymer in the form of said aqueous polymer latex and at least one further ingredient which is conventionally used in waterborne coating compositions and which is not a binder.

The present invention relates to aqueous polymer latices of film-forming copolymers obtainable by aqueous emulsion polymerisation of ethylenically unsaturated monomers M, which comprise a combination of a methylene-γ-butyrolactone with (meth)acrylate esters as monomers. The present invention also relates to a process for producing such polymer latices and to the use of these polymer latices as binders in waterborne coating compositions. Furthermore, the present invention relates to a waterborne coating composition which contains a binder polymer in the form of the aqueous polymer latex, as defined herein, and at least one further ingredient, which is conventionally used in waterborne coating compositions and which is not a binder.

Polymer latices, also referred to as polymer dispersions, are commonly known in particular as a binder or binder component, also termed co-binder, for coating compositions. As a binder or co-binder in coating compositions, one of the important requirements is that they provide hardness to the coatings and adherence of the coating to the coated surface. Furthermore, the polymer latex should provide good opacity, good stain removal properties and low dirt pick-up as well as low water uptake.

Despite the progress made in many respects, it remains a challenging task to provide polymer dispersions with a balanced application profile, as not only the application properties, but also the stability of the polymer dispersion has to be considered. In particular, it is difficult to reconcile the different coating property requirements at the same time through the binder. As a rule, the attempt to improve one property of the coating through changes in the polymer composition of the binder leads to other properties of the coating deteriorating significantly.

While the polymer dispersions described in the art have particular advantages in one or more aspects, they do not always have a well-balanced application profile. Apart from that, they are solely based on monomers which are prepared from fossil sources. In view of the ongoing discussion about the impact of CO₂ emission, there is a demand of replacing at least partly fossil by bio-based carbon in the polymer latices. The term bio-based means that the monomers are at least partly prepared from renewable raw materials, such as plants, parts of plants, plant waste, biomass and the like. These products are referred to as bio-based and are characterized by having a traceable content of ¹⁴C carbon. It is also possible that these materials are converted into suitable feeds, such as bio-naphtha as e.g. described in EP 2 290 045 A1 or EP 2 290 034 A1. Such feeds typically enter the chemical production system, such as a steam cracker, where they are converted into products along the chemical value chain, such as acrylic acid, methacrylic acid, acrylic esters, methacrylic esters and others. The content of renewable material of these products is defined by the mass balance approach and can be allocated to these products.

WO 2014/207389 describes the use of 2-octyl acrylate from renewable resources in the production of a polymer latex. The polymer latex is suggested as a binder. However, large amounts of 2-octyl acrylate in the monomers which form the latex will result in low glass transition temperatures of the resulting polymer, because homopolymers of 2-octyl acrylate have a glass transition temperature of below −40° C. Thus, a latex having a suitable glass transition temperature will require considerable amounts of conventional fossil-based monomers.

WO 2018/118221 describes copolymer latices comprising monomers having a high content of biorenewable carbon, whose homopolymers have a high glass transition temperature, in particular isobornyl methacrylate. However, isobornyl methacrylate may cause problems during emulsion polymerization and may result in instable polymer latices (see e. g. O. Llorente et al. Progress in Organic Coatings 172 (2022) 107137).

WO 2022/018013 describes polymer latices based on acrylate monomers, methacrylate monomers and/or monovinyl aromatic monomers which contain a certain quantity of monomers selected from isobutyl acrylate and isoamyl acrylate and mixtures thereof.

The coating compositions prepared therefrom result in coatings having improved coating properties such as whitening resistance, water-uptake and flexibility of the coating. Isobutyl acrylate and isoamyl acrylate can be—at least with regard to their alkanol part—obtained from biological sources and thus allow for the reduction of fossil carbon in the polymer latices.

JP2022083035 and JP2022140384 describes copolymers of α-methylene lactones, such as α-methylene valerolactone or α-methylene-γ-butyrolactone with methacrylate esters such as benzyl methacrylate and methyl methacrylate which are prepared by aqueous suspension polymerization followed by filtration of the polymer from the aqueous polymerization mixture. No stable latices were obtained and the polymers are not suitable as binders for coating waterborne coating compositions.

Yet, there is still need to provide polymer latices, which are at least partly based on bio-based monomers and which have an acceptable or improved application profile which renders them suitable as binders in waterborne coating compositions, in particular in waterborne coating compositions for exterior and interior application.

It was surprisingly found that polymer latices based on a certain quantity of a monomer M1 which is a methylene-γ-butyrolactone and which is in particular α-methylene-γ-butyrolactone, in combination with other conventional or biobased monomers M2 as defined herein, improve the coating properties of coating compositions, in particular of waterborne coating compositions, namely hardness, wet and dry adhesion to coated surfaces, in particular the adhesion of the coating to a surface previously coated with alkyd resins (alkyd adhesion), gloss and dirt pick-up, without deteriorating other properties such as spreading rate (opacity), wet and dry intercoat adhesion and stain removal properties. Moreover, the monomers M1 can be obtained from biological sources and thus allow for the reduction of fossil carbon in the polymer latices.

The present invention therefore relates to aqueous polymer latices of a copolymer obtainable by aqueous emulsion polymerisation of ethylenically unsaturated monomers M, which comprise
i. 2 to 70% by weight, in particular 5 to 65% by weight, preferably 10 to 60% by weight, especially 5 to 40% by weight or 10 to 40% by weight, based on the total amount of monomers M, of a monomer M1, which is a methylene-γ-butyrolactone and which is in particular α-methylene-γ-butyrolactone;
ii. 20 to 95% by weight, in particular 20 to 90% by weight or 20 to 85% by weight, especially 30 to 80% by weight, based on the total amount of monomers M, of at least one monomer M2, which is selected from C₂-C₂₀-alkyl esters of acrylic acid, except for tert-butyl acrylate, and C₅-C₂₀-alkyl esters of methacrylic acid and mixtures thereof;
iii. 0 to 40% by weight, in particular 0 to 35% by weight, especially 0 to 30% b weight, based on the total amount of monomers M, of one or more monomer M3, which is selected from tert.-butyl acrylate, C₁-C₄-alkyl esters of methacrylic acid, cyclopentyl methacrylate, cyclohexyl methacrylate, isobornyl methacrylate and monovinyl aromatic monomers and mixtures thereof;
where the total amount of monomers M1 and M3 is in the range of 5 to 70% by weight, in particular in the range of 10 to 65% by weight, and especially in the range of 15 to 60 by weight, based on the total amount of ethylenically unsaturated monomers M, and where the total amount of monomers M1, M2 and M3 is at least 85% by weight, based on the total amount of ethylenically unsaturated monomers M.

The present invention also relates to a process for producing the aqueous polymer latices of the present invention. The process comprises performing an aqueous emulsion polymerisation of the monomers M.

The present invention also relates to the use of these polymer latices as binders in waterborne coating compositions.

Furthermore, the present invention relates to waterborne coating compositions which contain
a) a binder polymer in the form of the aqueous polymer latex as defined herein; and
b) at least one further ingredient, which is conventionally used in waterborne coating compositions and which is not a binder, in particular at least one of inorganic pigments and inorganic fillers.

The present invention is associated with several benefits.
The polymer latices are stable and provide a good and well balanced application profile to waterborne coating compositions, such as improved hardness, improved adhesion properties such as high alkyd adhesion in the wet and in the dry state, improved gloss, decreased dirt pick-up, good spreading rate (opacity), high intercoat adhesion and good stain removal properties.
Since the polymer latices contain considerable amounts of monomers M1, M2 and M3, which at least with respect to monomers M1 and also with respect to some of the monomers M2 and M3 can be obtained from bio-renewable sources, they allow for a significant reduction in the need of fossil carbon, in particular by at least 10%, especially at least 25% or even at least 40%, e. g. 55%, and up to 100%. The incorporation of bio-carbon and the reduction of fossil carbon can reduce the carbon footprint of the polymer latex.

Due to their well-balanced application profile, the polymer latices are particularly useful as binders in waterborne architectural coatings, and have beneficial properties both in waterborne primers and in water-borne top coat formulations and exterior and interior architectural paints.

Here and throughout the specification, the term “bio-based monomer” means that the respective monomer is at least partly produced from molecules which are obtained from a bio-renewable resource, such as biomass. Such molecules are characterized by a content of bio-carbon of at least 90 mol-%, preferably at least 95 mol-%, e.g. 100 mol-%, based on the total amount of carbon atoms.

The term “bio-carbon” indicates that the carbon is of biological origin and comes from a biomaterial/renewable resources. Here and in the following renewable sources and bio-renewable sources are used synonymously and refer to sources of biological origin other than fossil sources. The content in bio-carbon and the content in biomaterial are expressions that indicate the same value. A material of renewable origin or biomaterial is an organic material wherein the carbon comes from the CO₂ fixed recently (on a human scale) by photosynthesis from the atmosphere. A biomaterial (carbon of 100% natural origin) has an isotopic ratio ¹⁴C/¹²C greater than 10⁻¹², typically about 1.2×10⁻¹², while a fossil material has a zero ratio. Indeed, the isotopic ¹⁴C is formed in the atmosphere and is then integrated via photosynthesis, according to a time scale of a few tens of years at most. The half-life of the ¹⁴C is 5,730 years. Thus, the materials coming from photosynthesis, namely plants in general, necessarily have a maximum content in isotope ¹⁴C. The determination of the content of biomaterial or of bio-carbon can be carried out in accordance with the standards ASTM D 6866-12, the method B (ASTM D 6866-06) and ASTM D 7026 (ASTM D 7026-04).

Here and throughout the specification, the term “(meth)acryl” includes both acryl and methacryl groups. Hence, the term “(meth)acrylate” includes acrylate and methacrylate and the term “(meth)acrylamide” includes acrylamide and methacrylamide.

Here and throughout the specification, the term “waterborne coating composition” means a liquid aqueous coating composition containing water as the continuous phase in an amount sufficient to achieve flowability.

Here and throughout the specification, the terms “wt.-%” and “% by weight (% b.w.)” are used synonymously.

Here and throughout the specification, the term “pphm” means parts per 100 monomers, i.e. parts by weight per 100 parts of monomers and corresponds to the relative amount in % by weight of a certain substance based on the total amount of monomers M.

Here and throughout the specification, the term “ethylenically unsaturated monomer” is understood that the monomer has at least one C═C double bond, e.g. 1, 2, 3 or 4 C═C double bonds, which are radically polymerizable, i.e. which under the conditions of an aqueous radical emulsion polymerization process are polymerized to obtain a polymer having a backbone of carbon atoms. Here and throughout the specification, the term “monoethylenically unsaturated” is understood that the monomer has a single C═C double bond, which is susceptible to radical polymerization under conditions of an aqueous radical emulsion polymerization.

Here and throughout the specification, the terms “ethoxylated” and “polyethoxylated” are used synonymously and refer to compounds having an oligo- or polyoxyethylene group, which is formed by repeating units O—CH₂CH₂. In this context, the term “degree of ethoxylation” relates to the number average of repeating units O—CH₂CH₂ in these compounds.

Here and throughout the specification, the term “non-ionic” in the context of compounds, especially monomers, means that the respective compound does not bear any ionic functional group or any functional group which can be converted by protonation or deprotonation into an ionic group.

Here and throughout the specification, the prefixes Cₙ-Cₘ used in connection with compounds or molecular moieties each indicate a range for the number of possible carbon atoms that a molecular moiety or a compound can have. The term “C₁-C₄ alkyl” denominates a group of linear or branched saturated hydrocarbon radicals having from 1 to n carbon atoms. The term “Cₙ/Cₘ alkyl” denominates a mixture of two alkyl groups, one having n carbon atoms while the other having m carbon atoms.

For example, the term C₁-C₂₀ alkyl denominates a group of linear or branched saturated hydrocarbon radicals having from 1 to 20 carbon atoms, while the term C₁-C₄ alkyl denominates a group of linear or branched saturated hydrocarbon radicals having from 1 to 4 carbon atoms and the C₅-C₂₀ alkyl denominates a group of linear or branched saturated hydrocarbon radicals having from 5 to 20 carbon atoms. Examples of alkyl include but are not limited to methyl, ethyl, n-propyl, isopropyl, n-butyl, sec-butyl, isobutyl, tert-butyl, 2-methylpropyl (isopropyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, 2-ethylhexyl, nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl and in case of nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl their isomers, in particular mixtures of isomers such as “isononyl”, “isodecyl”. Examples of C₁-C₄-alkyl are for example methyl, ethyl, propyl, 1-methylethyl, butyl, 1-methylpropyl, 2-methylpropyl or 1,1-dimethylethyl.

The term “cyclopentyl” as used herein refers to a monocyclic cycloaliphatic radical with 5 carbon atoms, which is unsubstituted or substituted by 1, 2, 3 or 4 methyl radicals and which is in particular unsubstituted.

The term “cyclohexyl” as used herein refers to a monocyclic cycloaliphatic radical with 6 carbon atoms, which is unsubstituted or substituted by 1, 2, 3 or 4 methyl radicals and which is in particular unsubstituted.

The term “isobornyl” refers to the radical 1,7,7-trimethylbicyclo[2.2.1]heptyl.

According to the invention, the monomers M comprise a monomer M1 which is methylene-γ-butyrolactone and which is in particular α-methylene-γ-butyrolactone. Methylene-γ-butyrolactones, such as α-methylene-γ-butyrolactone have an exocyclic double bond which is susceptible to a radical polymerization. In particular, the monomer M1 is α-methylene-γ-butyrolactone which has a high reactivity but which despite of its hydrolytically labile lactone structure can surprisingly be subjected to an emulsion polymerization without formation of ring-opened by-products. Here and in the following, α-methylene-γ-butyrolactone is also referred to as 2-methylene-γ-butyrolactone or 3-methylideneoxolan-2-one.

The total amount of monomers M1 is from 2 to 70% by weight, in particular from 5 to 65% by weight or from 10 to 60% by weight, preferably from 10 to 50% by weight, especially from 5 to 40% by weight or 10 to 40% by weight, more specifically from 10 to 35% by weight or 10 to 30% by weight, based on the total weight of the monomers M.

Methylene-γ-butyrolactones, such as α-methylene-γ-butyrolactone, are commercially available. They are preferably biobased, i. e. they can be obtained from biological sources. For example, α-methylene-γ-butyrolactone is a naturally occurring compound and known as Tulipalin A. α-Methylene-γ-butyrolactone can be produced from tetrahydro-3-furoic acid as described in U.S. Pat. No. 6,362,346.

α-Methylene-γ-butyrolactone can also be produced from itaconic acid by the process described in PCT/EP2022/077180 which is incorporated herein by reference. The process includes the enzymatic reduction of itaconic acid to 2-methylene-4-hydroxybutanoic acid which spontaneously lactonizes internally to 2-methylene-γ-butyrolactone. The process includes the enzymatic production of itaconyl-CoA, e. g. by using an acyl-CoA synthetase or a CoA transferase followed by the reaction with an oxidoreductase, e. g. an Acyl-CoA reductase, whereby itaconic acid semi-aldehyde is formed. Alternatively, itaconic acid semi-aldehyde can be obtained directly from itaconic acid by reaction with a carboxylic acid reductase. The itaconic acid semi-aldehyde is then reacted with an oxidoreductase, in particular an alcohol dehydrogenase or a 3-sulfolactaldehyde reductase to obtain 2-methylene-4-hydroxybutanoic acid which either spontaneously forms α-methylene-γ-butyrolactone. In some cases a further enzyme for lactonization may be required, e.g. a thioesterase or a lactonase. For example, 2-methylene-4-hydroxybutyric-CoA may be obtained, depending on the enzyme used in the first step. In this case, 2-methylene-4-hydroxybutyric-CoA will be reacted with a thioesterase to obtain α-methylene-γ-butyrolactone. The starting material itaconic acid can be produced by biotechnological processes from carbohydrates, such as glucose or glucose containing raw materials. A review is given by M. Okabe et al. Biotechnological Production of Itaconic Acid and its Biosynthesis from Aspergillus terreus. In: Applied Microbiology and Biotechnology 84 (4), 2009, S. 597-606 and by Garabed Antranikian: Angewandte Mikrobiologie, Springer-Verlag, Berlin/Heidelberg 2006, ISBN 3-540-24083-7, pp. 351-352.

Preference is given to methylene-γ-butyrolactones, such as α-methylene-γ-butyrolactone, which are bio-based and preferably have a content of bio-carbon of at least 90 mol-%, in particular at least 95 mol-% or at least 98 mol %, e.g. 100 mol-%, based on the total amount its of carbon atoms. Therefore, a particular embodiment of the invention relates to a polymer latex as defined herein, wherein at least 90 mol-%, preferably at least 95 mol-% or at least 98 mol %, e.g. 100 mol-% of he carbon atoms of the monomer M1 are of biological origin.

The monomers M2 and M3 may also be bio-based monomers, in particular if the monomers M2 and M3 are esters of acrylic acid or methacrylic acid. In this case, the alcohol portion of the ester may be bio-based. For example, bio-based ethanol, isobutanol, 2-methylbutyl alcohol, isoamyl alcohol (isopentanol), 2-octanol, cyclopentanol or isoborneol having a content of bio-carbon of at least 90 mol-%, preferably at least 95 mol-% or at least 98 mol %, e.g. 100 mol-%, based on the total amount of their carbon atoms, are readily obtainable on large scale.

The acrylic acid and/or methacrylic acid used for esterification may be obtained from fossil sources according to standard procedures. Acrylic acid may also be prepared from renewable raw materials, e.g. according to WO 2006/092272 or DE 10 2006 039 203 A or EP 2 922 580.

Consequently, the monomers M2 and M3 may have a content of bio-carbon of preferably at least 30 mol-%, in particular at least 40 mol-%, based on the total amount of carbon atoms in monomers M2 and M3, respectively. By using monomers M2 and M3, if present, which are at least partly of biological origin, the demand of fossil carbon in the polymer latex can be significantly reduced. In particular, an amount of carbon of biological origin in the latex of at least 10 mol-%, in particular at least 15 mol-% or at least 20 mol-% or higher, e.g. at least 30 mol-% or at least 40 mol-% or at least 50 mol-% or higher can be achieved.

In addition to the monomers M1, the monomers M forming the polymer of the latex comprise one or more monomers M2 as defined above.

Suitable monomers M2 are selected from the group consisting of:

C₂-C₂₀-alkyl esters of acrylic acid, except for tert-butyl acrylate, including, but not limited to, ethyl acrylate, n-propyl acrylate, n-butyl acrylate, isobutyl acrylate, n-pentyl acrylate, 2-methylbutyl acrylate, isoamyl acrylate, n-hexyl acrylate, n-heptyl acrylate, n-octyl acrylate, 2-octyl acrylate, 2-ethylhexyl acrylate, n-decyl acrylate, isodecyl acrylate, 2-propylheptyl acrylate, lauryl acrylate, C₁₂/C₁₄-alkyl acrylate, C₁₂-C₁₅-alkyl acrylate, isotridecyl acrylate, C₁₇-alkyl acrylate, C₁₆/C₁₈-alkyl acrylate and stearyl acrylate;
C₅-C₂₀-alkyl esters of methacrylic acid, including, but not limited to, n-pentyl methacrylate, n-hexyl methacrylate, n-heptyl methacrylate, n-octyl methacrylate, 2-octyl methacrylate, 2-ethylhexyl methacrylate, n-decyl methacrylate, isodecyl methacrylate, 2-propylheptyl methacrylate, lauryl methacrylate, C₁₂/C₁₄-alkyl methacrylate, C₁₂-C₁₅-alkyl methacrylate, isotridecyl methacrylate, C₁₇-alkyl methacrylate, C₁₆/C₁₈-alkyl methacrylate and stearyl methacrylate; and
mixtures thereof.

Preferred monomers M2 are selected from the group consisting of ethyl acrylate, n-propyl acrylate, n-butyl acrylate, isobutyl acrylate, n-pentyl acrylate, 2-methylbutyl acrylate, isoamyl acrylate, n-hexyl acrylate, n-heptyl acrylate, n-octyl acrylate, 2-octyl acrylate, 2-ethylhexyl acrylate, 2-propylheptyl acrylate and mixtures thereof. Preferably, the monomers M2 comprise at least one of n-butyl acrylate, 2-ethylhexyl acrylate, n-heptyl acrylate, n-octyl acrylate, 2-octyl acrylate, isoamyl acrylate (=3-methylbutyl acrylate; isopentyl acrylate), 2-methylbutyl acrylate and isobutyl acrylate or mixtures thereof. Ethyl acrylate, isoamyl acrylate, 2-methylbutyl acrylate, isobutyl acrylate, n-heptyl acrylate, n-octyl acrylate and 2-octyl acrylate may be produced from fossil sources or may be at least partly bio-based. In particular, the ethyl, isoamyl, 2-methylbutyl, isobutyl, n-heptyl, n-octyl and 2-octyl portion of ethyl acrylate, isoamyl acrylate, 2-methylbutyl acrylate isobutyl acrylate, n-heptyl acrylate, n-octyl acrylate and 2-octyl acrylate, respectively, is bio-based, i. e. the monomers are obtained from esterification of acrylic acid, which may be bio-based or of fossil origin, with biobased ethanol, isoamyl alcohol, 2-methylbutanol, isobutanol, n-heptanol, n-octanol or 2-octanol, respectively.

In a preferred group of embodiments, the monomers M2 comprise isobutyl acrylate, especially bio-based isobutyl acrylate. Especially, the monomer M2 is isobutyl acrylate, especially bio-based isobutyl acrylate. In this preferred group of embodiments, the monomers M2 may also be mixtures of isobutyl acrylate with at least one further C₂-C₁₀ alkyl acrylate which is different from isobutyl acrylate, such as n-butyl acrylate, isoamyl acrylate, 2-methylbutyl acrylate, n-heptyl acrylate, n-octyl acrylate, 2-octyl acrylate and 2-ethylhexyl acrylate.

In the context of this group of embodiments, it is preferred that the amount of isobutyl acrylate is in the range of 20 to 90% by weight or 20 to 85% by weight, in particular 25 to 80% by weight or 30 to 80% by weight, more particularly 35 to 80% by weight, specifically 40 to 80% by weight and more specifically 50 to 80% by weight, based on the total amount of monomers M.

The acrylates, such as isobutyl acrylate, 2-methylbutyl acrylate, isopentyl acrylate and 2-octyl acrylate, are typically produced by esterification of acrylic acid with the respective alcohol, such as isobutanol (2-methylpropan-1-ol), 2-methylbutanol, isopentanol (3-methylbutan-1-ol; isoamyl alcohol) or 2-octanol, respectively, or, especially in case of acrylates derived from higher alcohols, by transesterification of methyl acrylate or ethyl acrylate with the respective alcohol, such as isobutanol (2-methylpropan-1-ol), 2-methylbutan-1-ol, isopentanol (3-methylbutan-1-ol) or 2-octanol, respectively.

Isobutanol, 2-methylbutanol and isopentanol, as well as mixtures thereof, can be produced on large scale by fermentation from a variety of renewable feedstocks, including corn, wheat, sorghum, barley, and sugar cane, in particular from cellulose-containing raw material and thus from biological sources or renewable raw materials, respectively. In particular, fermentation may produce a mixture comprising different alkanols from which isobutanol, 2-methylbutan-1-ol and 3-methylbutan-1-ol can be separated by conventional techniques such as fractionated distillation. Thereby either the pure alcohols (purity >90%) may be obtained or mixtures containing at least two alcohols selected from the group consisting of isobutanol, 2-methylbutan-1-ol and 3-methylbutan-1-ol in a total amount of at least 80%, in particular at least 90% can be obtained. For example, a mixture comprising at least 80% by weight of a mixture of 2-methyl butanol and 3-methyl butanol and up to 20% by weight of isobutanol may be used for esterification or trans-esterification. In this mixture the molar ratio of 3-methylbutanol to 2-methylbutan-1-ol may vary, e.g. from 1:10 to 10:1 and is in particular in the range of 1:1 to 10:1. 2-Octanol can be produced by alkali-catalyzed thermal cleavage of ricinoleic acid with sebacic acid as a coproduct. Castor oil, which consists mainly of ricinoleic acid, is the main feedstock. Therefore, including these monomers M2 into the polymer latex significantly increases the amount of bio-carbon in the polymer latex. The incorporation of bio-carbon and the reduction of fossil carbon can reduce the carbon footprint of the polymer latex.

Therefore, a particular embodiment of the invention relates to a polymer latex as defined herein, wherein at least the carbon atoms of the isobutyl group, the 2-methylbutyl group, the isoamyl group and the 2-octyl group, respectively, in the monomers M2, in particular at least the carbon atoms of the isobutyl group in the monomers M2 are of biological origin, i.e. they are at least partly made of bio-carbon. In particular, the isobutanol, the 2-methylbutan-1-ol, the 3-methylbutanol and the 2-octanol, respectively, used for the production of the monomers M2 preferably have a content of bio-carbon of at least 90 mol-%, based on the total amount of carbon atoms in isobutanol, 2-methylbutanol, 3-methylbutanol and 2-octanol, respectively. This content is advantageously higher, in particular greater than or equal to 95 mol-%, preferably greater than or equal to 98 mol-% and advantageously equal to 100 mol-%. Similarly, acrylic acid may be produced from renewable materials. However, acrylic acid produced from biomaterials is not available on large scale so far. Consequently, the monomers M2 have a content of bio-carbon of preferably at least 51 mol-%, in particular at least 54 mol-% and especially at least 57 mol-%, based on the total amount of carbon atoms in isobutyl acrylate, 2-methylbutyl acrylate, isoamyl acrylate and 2-octyl acrylate, respectively. By using monomers M2, which are at least partly of biological origin, the demand of fossil carbon in the polymer latex can be significantly reduced. In particular, an amount of carbon of biological origin of at least 10 mol-%, in particular at least 15 mol-% or at least 20 mol-% or higher, e.g. 30 mol-% or 40 mol-% or higher can be achieved.

The total amount of monomers M2 is from 20 to 95% by weight or 20 to 90% by weight, in particular from 30 to 85% by weight or 30 to 80% by weight or from 35 to 80% by weight, especially from 40 to 80% by weight, and more specifically 50 to 80% by weight, based on the total weight of the monomers M.

In addition to the monomers M1 and M2, the monomers M forming the polymer of the latex may comprise one or more monomers M3 as defined above.

Suitable monomers M3 are selected from the group consisting of:
C₁-C₄-alkyl esters of methacrylic acid, such as methyl methacrylate, ethyl methacrylate, n-propyl methacrylate, isopropyl methacrylate, n-butyl methacrylate, sec-butyl methacrylate, isobutyl methacrylate and tert-butyl methacrylate;
tert-butyl acrylate;
cyclopentyl methacrylate, cyclohexyl methacrylate, isobornyl methacrylate;
monovinyl aromatic monomers, such as styrene, 2-methylstyrene, 4-methylstyrene; and
mixtures thereof.

In a preferred group of embodiments, monomers M3 are selected from the group consisting of:
C₁-C₄-alkyl esters of methacrylic acid, in particular methyl methacrylate, ethyl methacrylate, n-butyl methacrylate, isobutyl methacrylate and tert-butyl methacrylate;
tert-butyl acrylate;
cyclopentyl methacrylate, cyclohexyl methacrylate, isobornyl methacrylate;
styrene; and
mixtures thereof.

In this group, monomers M3 are particularly selected from the group consisting of:
methyl methacrylate, n-butyl methacrylate;
tert-butyl acrylate;
cyclopentyl methacrylate, cyclohexyl methacrylate, isobornyl methacrylate;
styrene; and
mixtures thereof.

In a particular group of embodiments (M3-A), the monomers M3 comprise methyl methacrylate in an amount of at least 50% by weight, in particular at least 80% by weight or 100% by weight, based on the total amount of monomers M3 in the monomers M. In this group, more particularly, the monomer M3 is selected from the group consisting of methyl methacrylate and combinations of methyl methacrylate with n-butyl methacrylate, tert-butyl acrylate, cyclopentyl methacrylate, cyclohexylmethacrylate, isobornylmethacrylate or with styrene.

In this particular group M3-A of embodiments, preference is given to the monomer M3 being methyl methacrylate.

In the context of the group M3-A of embodiments, it is preferred that the amount of methyl methacrylate, if present in monomers M, is in the range of 1 to 40% by weight, in particular 1.5 to 35%, especially 2 to 30%, more specifically 10 to 20% by weight, based on the total amount of monomers M.

In another particular group of embodiments (M3-B), the monomers M3 comprise styrene in an amount of at least 50% by weight, in particular at least 80% by weight or 100% by weight, based on the total amount of monomers M3 in the monomers M. In this group, more particularly, the monomer M3 is selected from the group consisting of styrene and combinations of styrene with methyl methacrylate, n-butyl methacrylate, tert-butyl acrylate, cyclopentyl methacrylate, cyclohexyl methacrylate or isobornyl methacrylate.

In this particular group M3-B of embodiments, preference is given to the monomer M3 being styrene.

In the context of the group M3-B of embodiments, it is preferred that the amount of styrene is in the range of 1 to 30% by weight, in particular 1.5 to 25%, especially 2 to 20%, based on the total amount of monomers M.

The total amount of monomers M3 is from 0 to 40% by weight, in particular from 0 to 35% by weight or from 1 to 35% by weight, specifically from 0 to 30% by weight or from 2 to 30% by weight, more specifically from 0 to 20% by weight or from 10 to 20% by weight, based on the total weight of the monomers M.

The total amount of monomers M1 and M3 is preferably in the range from 5 to 70% by weight, in particular in the range from 10 to 65% by weight, especially in the range of 15 to 60% by weight, based on the total amount of ethylenically unsaturated monomers M.

The total amount of monomers M1, M2 and M3 is at least 85% by weight, in particular at least 90% by weight, especially at least 95% by weight, based on the total amount of ethylenically unsaturated monomers M.

The weight ratio of M1 to M2 is generally in the range of 1:10 to 10:1, in particular 1:5 to 5:1, preferably in the range of 1:5 to 4:1, especially in the range of 1:5 to 3.5:1, more specifically in the range of 1:5 to 1:1, and even more specifically in the range of 1:5 to 1:2.

If M3 is present, the weight ratio of M1 to M3 is generally in the range of 1:5 to 30:1, in particular 1:4 to 25:1, preferably in the range of 1:2 to 20:1.

The monomers M may further comprise at least one monomer M4, which is selected from monoethylenically unsaturated monomers having an acidic group.

Suitable monomers M4 include, but are not limited to
monoethylenically unsaturated monocarboxylic acids having 3 to 6 carbon atoms, such as acrylic acid, methacrylic acid, crotonic acid, 2-ethylpropenoic acid, 2-propylpropenoic acid, 2-acryloxyacetic acid and 2-methacryloxyacetic acid;
monoethylenically unsaturated dicarboxylic acids having 4 to 6 carbon atoms, such as itaconic acid, citraconic acid and fumaric acid;
semi-esters of monoethylenically unsaturated dicarboxylic acids having 4 to 6 carbon atoms, with C₁-C₄ alkanols, such as methanol or ethanol, such as semi-esters of itaconic acid, citraconic acid, maleic acid or fumaric acid with methanol or ethanol;
monoethylenically unsaturated sulfonic acids, such as vinylsulfonic acid, allylsulfonic acid, styrenesulfonic acid, 2-acrylamido-2-methylpropane sulfonic acid,
monoethylenically unsaturated phosphonic acids such as vinylphosphonic acid, allylphosphonic acid, styrenephosphonic acid and 2-acrylamido-2-methylpropane phosphonic acid,
monoethylenically unsaturated phosphoric acids such as monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, in particular monophosphates of hydroxyethyl acrylate, hydroxypropyl acrylate or hydroxybutyl acrylate, monophosphates of hydroxyethyl methacrylate, hydroxypropyl methacrylate or hydroxybutyl methacrylate, monophosphates of ethoxylated hydroxy-C₂-C₄-alkyl acrylates, monophosphates of propoxylated hydroxy-C₂-C₄-alkyl acrylates, monophosphates of ethoxylated hydroxy-C₂-C₄-alkyl methacrylates and monophosphates of propoxylated hydroxy-C₂-C₄-alkyl methacrylates.

The aforementioned monomers M4 can be present in their acidic form or in the form of their salts, in particular in the form of their alkalimetal salts or ammonium salts.

Amongst the aforementioned monomers M4, preference is given to monoethylenically unsaturated monocarboxylic acids, monoethylenically unsaturated dicarboxylic acids and monoethylenically unsaturated sulfonic acids and the salts thereof, in particular the alkalimetal salts and ammonium salts. Particular preference is given to acrylic acid, methacrylic acid, itaconic acid, 2-acrylamido-2-methylpropane sulfonic acid and the salts thereof, in particular the alkalimetal salts and ammonium salts, and combinations thereof. More preference is given to monoethylenically unsaturated monocarboxylic acids and monoethylenically unsaturated sulfonic acids and the salts thereof, in particular the alkalimetal salts and ammonium salts, in particular to acrylic acid, methacrylic acid, 2-acrylamido-2-methylpropane sulfonic acid, the salts thereof, in particular the alkalimetal salts and ammonium salts and mixtures of the aforementioned monomers. In a particular group of embodiments, the monomer M4 comprises methacrylic acid. Especially, the monomer M4 is methacrylic acid or a mixture of acrylic acid and methacrylic acid. In another particular group of embodiments, the monomer M4 comprises acrylic acid. In another particular group of embodiments, the monomer M4 comprises 2-acrylamido-2-methylpropane sulfonic acid or a salt thereof, in particular an alkalimetal salt or an ammonium salt. Especially, the monomer M4 is 2-acrylamido-2-methylpropane sulfonic acid or a salt thereof, in particular an alkalimetal salt or an ammonium salt or a mixture of acrylic acid and 2-acrylamido-2-methylpropane sulfonic acid or a salt thereof, in particular an alkalimetal salt or an ammonium salt. In another specific embodiment, the monomer M4 is acrylic acid.

The total amount of monomers M4 is from 0.05 to 5% by weight or from 0.1 to 4% by weight, in particular from 0.05 to 3.5% by weight or from 0.1 to 3% by weight, especially from 0.2 to 3% by weight or from 0.5 to 3% by weight or from 0.5 to 2% by weight, based on the total weight of the monomers M.

The monomers M may further comprise at least one monoethylenically unsaturated, non-ionic monomer M5, which has a solubility in deionized water at 20° C. and 1 bar of at least 60 g/L.

Suitable monomer M5 is selected from the group consisting of non-ionic monoethylenically unsaturated monomers which have a functional group selected from the group consisting of hydroxyalkyl groups, in particular hydroxy-C₂-C₄-alkyl group, a primary carboxamide group, urea groups, keto groups and combinations thereof.

The total amount of monomers M5 will usually not exceed 10% by weight, in particular 7% by weight, based on the total amount of monomers M. In particular, the total amount of monomers M5 is usually 0 to 9.95% by weight, if present, from 0.05 to 9.95% by weight, in particular 0.1 to 7% by weight, especially from 0.1 to 5% by weight or 0.1 to 4% by weight or 0.5 to 3% by weight or 1 to 3% by weight or 0.5 to 2% by weight, based on the total weight of the monomers M.

Examples for monomers M5 having a carboxamide group (hereinafter monomers M5a) include, but are not limited to primary amides of monoethylenically unsaturated monocarboxylic acids having 3 to 6 carbon atoms, such as acrylamide and methacrylamide, and C₁-C₄-alkylamides of monoethylenically unsaturated monocarboxylic acids having 3 to 6 carbon atoms, such as N-methyl acrylamide, N-ethyl acrylamide, N-propyl acrylamide, N-isopropyl acrylamide, N-butyl acrylamide, N-methyl methacrylamide, N-ethyl methacrylamide, N-propyl methacrylamide, N-isopropyl methacrylamide and N-butyl methacrylamide. Most preferably, monomer M5a is selected from acrylamide and methacrylamide.

Examples for monomers M5 having a urea group (hereinafter monomers M5b) are the C₁-C₄-alkyl esters of acrylic acid or methacrylic acid and the N—C₁-C₄-alkyl amides of acrylic acid or methacrylic acid, where the C₁-C₄-alkyl group bears an urea group or a 2-oxoimidazolin group such as 2-(2-oxo-imidazolidin-1-yl)ethyl acrylate, 2-(2-oxo-imidazolidin-1-yl)ethyl methacrylate, which are also termed 2-ureido acrylate and 2-ureido methacrylate, respectively, N-(2-acryloxyethyl)urea, N-(2-methacryloxyethyl)urea, N-(2-(2-oxo-imidazolidin-1-yl)ethyl) acrylamide, N-(2-(2-oxo-imidazolidin-1-yl)ethyl) methacrylamide, as well as allyl or vinyl substituted ureas and allyl or vinyl substituted 2-oxoimidazolin compounds such as 1-allyl-2-oxoimidazolin, N-allyl urea and N-vinylurea.

Examples for monomers M5 having a keto group (hereinafter monomers M5c) are the
C₂-C₈-oxoalkyl esters of acrylic acid or methacrylic acid and the N—C₂-C₈-oxoalkyl amides of acrylic acid or methacrylic acid, such as diacetoneacrylamide (DAAM), and diacetonemethacrylamide, and
C₁-C₄-alkyl esters of acrylic acid or methacrylic acid and the N—C₁-C₄-alkyl amides of acrylic acid or methacrylic acid, where the C₁-C₄-alkyl group bears a 2-acetylacetoxy group of the formula O—C(═O)—CH₂—C(═O)—CH₃ (also termed acetoacetoxy group), such as acetoacetoxyethyl acrylate, acetoacetoxypropyl methacrylate, acetoacetoxybutyl methacrylate and 2-(acetoacetoxy)ethyl methacrylate.

Preferably, the monomers M comprise or consist of:
i. 5 to 70% by weight, in particular 10 to 65% by weight or 10 to 60% by weight, preferably 10 to 50% by weight, especially 5 to 40% by weight or 10 to 40% by weight, more specifically from 10 to 35% by weight or 10 to 30% by weight, based on the total amount of monomers M, of a methylene-γ-butyrolactone, in particular α-methylene-γ-butyrolactone as a monomer M1;
ii. 20 to 90% by weight, in particular 30 to 80% by weight or 35 to 80% by weight, especially 40 to 80% by weight, and more specifically 50 to 80% by weight, based on the total amount of monomers M, of at least one monomer M2, which comprises or is isobutyl acrylate;
iii. 0 to 40% by weight or 1 to 40% by weight, in particular 0 to 35% by weight or 1 to 35% by weight, especially 5 to 40% by weight or 5 to 35% by weight, based on the total amount of monomers M, of at least one monomer M3, which comprises or is selected from the group consisting of methyl methacrylate, styrene or combinations thereof;
iv. 0.05 to 5% by weight, or 0.1 to 4% by weight, in particular 0.05 to 3.5% by weight or 0.1 to 3% by weight, especially 0.2 to 3% by weight or 0.5 to 3% by weight, or 0.5 to 2% by weight, based on the total amount of monomers M, of one or more monoethylenically unsaturated monomers M4, which is selected from monoethylenically unsaturated monomers having an acidic group;
v. 0 to 9.95% by weight, if present 0.05 to 9.95% by weight, in particular 0.1 to 7% by weight, especially 0.1 to 5% by weight or 0.1 to 4% by weight or 0.5 to 3% by weight or 1 to 3% by weight or 0.5 to 2% by weight, based on the total weight of the monomers M, of one or more non-ionic monomers M5 having a solubility in deionized water at 20° C. and 1 bar of at least 60 g/L,
where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M.

In a particular group 1 of embodiments, the monomers M comprise or consist of:
i. 10 to 69.95% by weight, in particular 15 to 64.85% by weight, preferably 20 to 59.4% by weight, especially 10 to 40% by weight, more specifically 15 to 35% by weight or 20 to 30% by weight, based on the total amount of monomers M, of α-methylene-γ-butyrolactone as a monomer M1;
ii. 30 to 89.95% by weight, in particular 35 to 84.85% by weight, especially 40 to 79.4% by weight, based on the total amount of monomers M, of isobutyl acrylate as a monomer M2;
iii. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
iv. 0 to 9.95% by weight, if present 0.05 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L,
where the total amount of monomers M1 and M2 is at least 85% by weight, in particular at least 90% by weight, especially at least 95% by weight, based on the total amount of ethylenically unsaturated monomers M;
or
i. 10 to 68.95% by weight, in particular 15 to 63.35% by weight, preferably 15 to 57.4% by weight, especially 15 to 40% by weight, more specifically 15 to 35% by weight or 15 to 30% by weight, based on the total amount of monomers M, of α-methylene-γ-butyrolactone as a monomer M1;
ii. 30 to 80% by weight, in particular 35 to 75% by weight, especially 40 to 75% by weight, based on the total amount of monomers M, of isobutyl acrylate as a monomer M2;
iii. 1 to 35% by weight, in particular 1.5 to 30% by weight, especially 2 to 25% by weight, based on the total amount of monomers M, of a monomer M3, which is selected from methyl methacrylate, styrene and combinations thereof;
iv. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
v. 0 to 9.95% by weight, if present 0.05 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L,
where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M;
or
i. 10 to 68.95% by weight, in particular 15 to 63.35% by weight, preferably 15 to 57.4% by weight, especially 15 to 40% by weight, more specifically 15 to 35% by weight or 15 to 30% by weight, based on the total amount of monomers M, of α-methylene-γ-butyrolactone as a monomer M1;
ii. 30 to 80% by weight, in particular 35 to 75% by weight, especially 40 to 75% by weight, based on the total amount of monomers M, of monomers M2 which are a mixture of isobutyl acrylate with at least one C₂—C alkyl acrylate, which is different from isobutyl acrylate, such as n-butyl acrylate, isoamyl acrylate, 2-methylbutyl acrylate, 2-octyl acrylate and 2-ethylhexyl acrylate;
iii. 1 to 35% by weight, in particular 1.5 to 30% by weight, especially 2 to 25% by weight, based on the total amount of monomers M, of a monomer M3, which is selected from methyl methacrylate, styrene and combinations thereof;
iv. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
v. 0 to 9.95% by weight, if present 0.05 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L, where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M.

In the particular group 1 of embodiments, the monomers M preferably comprise or consist of (group 1a of embodiments):
i. 10 to 69.95% by weight, in particular 15 to 64.85% by weight, preferably 20 to 59.4% by weight, especially 15 to 40% by weight, more specifically 15 to 35% by weight or 20 to 30% by weight, based on the total amount of monomers M, of α-methylene-γ-butyrolactone as a monomer M1, wherein at least 90 mol-%, in particular at least 95 mol-%, especially at least 95 mol-% or 100 mol-% of the carbon atoms of α-methylene-γ-butyrolactone are of biological origin;
ii. 30 to 89.95% by weight, in particular 35 to 84.85% by weight, especially 40 to 79.4% by weight, based on the total amount of monomers M, of isobutyl acrylate as a monomer M2, wherein at least the carbon atoms of the isobutyl groups in isobutyl acrylate are of biological origin, particularly the content of bio-carbon of isobutyl methacrylate is at least 54 mol-% in particular at least 57 mol-%;
iii. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
iv. 0 to 9.95% by weight, if present 0.05 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L,
where the total amount of monomers M1 and M2 is at least 85% by weight, in particular at least 90% by weight, especially at least 95% by weight, based on the total amount of ethylenically unsaturated monomers M;
or
i. 10 to 68.95% by weight, in particular 15 to 63.35% by weight, preferably 15 to 57.4% by weight, especially 15 to 40% by weight, more specifically 15 to 35% by weight or 15 to 30% by weight, based on the total amount of monomers M, of α-methylene-γ-butyrolactone as a monomer M1, wherein at least 90 mol-%, in particular at least 95 mol-%, especially at least 95 mol-% or 100 mol-% of the carbon atoms of α-methylene-γ-butyrolactone are of biological origin;
ii. 30 to 80% by weight, in particular 35 to 75% by weight, especially 40 to 75% by weight, based on the total amount of monomers M, of isobutyl acrylate as a monomer M2, wherein at least the carbon atoms of the isobutyl groups in isobutyl acrylate are of biological origin, particularly the content of bio-carbon of isobutyl methacrylate is at least 54 mol-% in particular at least 57 mol-%;
iii. 1 to 35% by weight, in particular 1.5 to 30% by weight, especially 2 to 25% by weight, based on the total amount of monomers M, of a monomer M3, which is selected from methyl methacrylate, styrene and combinations thereof;
iv. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
v. 0 to 9.95% by weight, if present 0.05 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L,
where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M;
or
i. 10 to 68.95% by weight, in particular 15 to 63.35% by weight, preferably 15 to 57.4% by weight, especially 15 to 40% by weight, more specifically 15 to 35% by weight or 15 to 30% by weight, based on the total amount of monomers M, of α-methylene-γ-butyrolactone as a monomer M1, wherein at least 90 mol-%, in particular at least 95 mol-%, especially at least 95 mol-% or 100 mol-% of the carbon atoms of α-methylene-γ-butyrolactone are of biological origin;
ii. 30 to 80% by weight, in particular 35 to 75% by weight, especially 40 to 75% by weight, based on the total amount of monomers M, of monomers M2 which are a mixture of isobutyl acrylate with at least one C₂—C alkyl acrylate, which is different from isobutyl acrylate, such as n-butyl acrylate, isoamyl acrylate, 2-methylbutyl acrylate, 2-octyl acrylate and 2-ethylhexyl acrylate, wherein at least the carbon atoms of the isobutyl groups in isobutyl acrylate are of biological origin, particularly the content of bio-carbon of isobutyl methacrylate is at least 54 mol-% in particular at least 57 mol-%;
iii. 1 to 35% by weight, in particular 1.5 to 30% by weight, especially 2 to 25% by weight, based on the total amount of monomers M, of a monomer M3, which is selected from methyl methacrylate, styrene and combinations thereof;
iv. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
v. 0 to 9.95% by weight, if present 0.05 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L,
where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M.

In addition to the aforementioned monomers M1, M2, M3, M4 and M5, the monomers M may comprise one or more further monomers, which are different from the aforementioned monomers M. Suitable monomers M which are different from the monomers M1, M2, M3, M4 and M5 include, but are not limited to
monomers M6, which are selected from monoethylenically unsaturated non-ionic monomers having a silane functional group or an epoxy group;
monomers M7, which are selected from multiethylenically unsaturated monomers, i.e. monomers having at least two non-conjugated ethylenically unsaturated double bounds;
monomers M8, which are selected from monoethylenically unsaturated copolymerizable UV-initiators.

Suitable monomers M6 include monoethylenically unsaturated silane functional monomers (monomers M6a), e.g. monomers which in addition to an ethylenically unsaturated double bond bear at least one mono-, di- and/or tri-C₁-C₄-alkoxysilane group, such as vinyl trimethoxysilane, vinyl triethoxysilane, methacryloxymethyl trimethoxysilane, methacryloxymethyl triethoxysilane, methacryloxypropyl trimethoxysilane, methacryloxypropyl triethoxysilane, methacryloxyethyl trimethoxysilane, methacryloxyethyl triethoxysilane, and mixtures thereof. Preference is given to methacryloxypropyl trimethoxysilane and vinyl triethoxysilane. The amount of silan functional monomers M6a, if present, will usually not exceed 1% by weight, and frequently be in the range of 0.01 to 1% by weight, preferably in the range of 0.05 to 0.7% by weight, based on the total amount of ethylenically unsaturated monomers M.

Suitable monomers M6 also include monoethylenically unsaturated monomers bearing at least one epoxy group (monomers M6b), in particular a glycidyl group such as glycidyl acrylate, glycidyl methacrylate, 2-glycidyloxyethyl acrylate and 2-glycidyloxyethyl methacrylate. The amount of monomers M6b, if present will usually not exceed 2% by weight, and frequently be in the range of 0.01 to 2% by weight, preferably in the range of 0.05 to 1% by weight, based on the total amount of ethylenically unsaturated monomers M.

The monomers M may also include multiethylenically unsaturated monomers (monomers M7), i.e. monomers having at least two non-conjugated ethylenically unsaturated double bounds. The amounts of said monomers M7 will generally not exceed 1% by weight, and frequently be in the range of 0 to 1% by weight, especially 0 to 0.5% by weight, based on the total amount of ethylenically unsaturated monomers M.

Examples of multiethylenically unsaturated monomers M7 include:
diesters of monoethylenically unsaturated C₃-C₆ monocarboxylic acids with saturated aliphatic or cycloaliphatic diols, in particular diesters of acrylic acid or methacrylic acid, such as the diacrylates and the dimethacrylates of ethylene glycol (1,2-ethanediol), propylene glycol (1,2-propanediol), 1,2-butanediol, 1,3-butanediol, 1,4-butanediol, neopentyl glycol (2,2-dimethyl-1,3-propanediol), 1,6-hexanediol and 1,2-cyclohexanediol;
monoesters of monoethylenically unsaturated C₃-C₆ monocarboxylic acids with monoethylenically unsaturated aliphatic or cycloaliphatic monohydroxy compounds, such as the acrylates and the methacrylates of vinyl alcohol (ethenol), allyl alcohol (2-propen-1-ol), 2-cyclohexen-1-ol or norbornenol, such as allyl acrylate and allyl methacrylate; and
divinyl aromatic compounds, such as 1,3-divinyl benzene, 1,4-divinyl benzene.

Polymerized monoethylenically unsaturated copolymerizable UV-initiators M8 result in a crosslinking of the polymer chain upon exposure to sunlight. Monomers M8 bear an ethylenically unsaturated double bond, in particular an acrylate or methacrylate group and a moiety that is decomposed by UV radiation whereby a radical is formed. Such groups are typically benzophenone groups, acetophenone groups, benzoin groups or carbonate groups attached to a phenyl ring. Such compounds are disclosed e.g. in EP 346734, EP 377199, DE 4037079, DE 3844444, EP 1213 and US2015/0152297. Examples include but are not limited to 4-acryloxybenzophenone (=4-benzoylphenyl propenoate), 4-methacryloxybenzophenone (=4-benzoylphenyl 2-methylpropenoate), 4-(2-acryloxyethoxy)benzophenone (=2-(4-benzoylphenoxy)ethyl propenoate), 4-(2-methacryloxyethoxy)benzophenone (=2-(4-benzoylphenoxy)ethyl 2-methyl-propenoate), O-(2-(meth)acryloxyethyl)-O-(benzoylphenyl) carbonate and O-(2-(meth)acryloxyethyl)-O-(acetylphenyl) carbonate. The amounts of said monomers M8 will generally not exceed 1% by weight, and, if present, are typically present in the range of 0.01 to 1% by weight, especially 0.02 to 0.5% by weight, based on the total amount of ethylenically unsaturated monomers M.

In particular, the monomers M consist of (group 2 of embodiments):
i. 10 to 69.95% by weight, in particular 15 to 64.85% by weight, preferably 20 to 59.4% by weight, especially 15 to 40% by weight, more specifically 15 to 35% by weight or 20 to 30% by weight, based on the total amount of monomers M, of α-methylene-γ-butyrolactone as a monomer M1, wherein at least 90 mol-%, in particular at least 95 mol-%, especially at least 95 mol-% or 100 mol-% of the carbon atoms of α-methylene-γ-butyrolactone are of biological origin;
ii. 30 to 89.95% by weight, in particular 35 to 84.85% by weight, especially 40 to 79.4% by weight, based on the total amount of monomers M, of isobutyl acrylate as a monomer M2, wherein at least the carbon atoms of the isobutyl groups in isobutyl acrylate are of biological origin, particularly the content of bio-carbon of isobutyl methacrylate is at least 54 mol-% in particular at least 57 mol-%;
iii. 0.05 to 5% by weight, in particular 0.1 to 4% by weight, especially 0.5 to 3% by weight, based on the total amount of monomers M, of one or more monoethylenically unsaturated monomers M4, which is selected from acrylic acid, methacrylic acid, itaconic acid and combinations thereof;
iv. 0 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L, which have a functional group selected from the group consisting of hydroxyalkyl groups, a primary carboxamide group, urea groups, keto groups and combinations thereof; and
v. 0 to 1% by weight, especially 0 to 0.5% by weight, of one or more monomers M7, based on the total weight of the monomers M;
where the total amount of monomers M1 and M2 is at least 85% by weight, in particular at least 90% by weight, especially at least 95% by weight, based on the total amount of ethylenically unsaturated monomers M;
or
i. 10 to 68.95% by weight, in particular 15 to 63.35% by weight, preferably 15 to 57.4% by weight, especially 15 to 40% by weight, more specifically 15 to 35% by weight or 15 to 30% by weight, based on the total amount of monomers M, of α-methylene-γ-butyrolactone as a monomer M1, wherein at least 90 mol-%, in particular at least 95 mol-%, especially at least 95 mol-% or 100 mol-% of the carbon atoms of α-methylene-γ-butyrolactone are of biological origin;
ii. 30 to 80% by weight, in particular 35 to 75% by weight, especially 40 to 75% by weight, based on the total amount of monomers M, of isobutyl acrylate as a monomer M2, wherein at least the carbon atoms of the isobutyl groups in isobutyl acrylate are of biological origin, particularly the content of bio-carbon of isobutyl methacrylate is at least 54 mol-% in particular at least 57 mol-%;
iii. 1 to 35% by weight, in particular 1.5 to 30% by weight, especially 2 to 25% by weight, based on the total amount of monomers M, of a monomer M3, which is selected from methyl methacrylate, styrene and combinations thereof;
iv. 0.05 to 5% by weight, in particular 0.1 to 4% by weight, especially 0.5 to 3% by weight, based on the total amount of monomers M, of one or more monoethylenically unsaturated monomers M4, which is selected from acrylic acid, methacrylic acid, itaconic acid and combinations thereof;
v. 0 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L, which have a functional group selected from the group consisting of hydroxyalkyl groups, a primary carboxamide group, urea groups, keto groups and combinations thereof; and
vi. 0 to 1% by weight, especially 0 to 0.5% by weight, of one or more monomers M7, based on the total weight of the monomers M;
where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M;
or
i. 10 to 68.95% by weight, in particular 15 to 63.35% by weight, preferably 15 to 57.4% by weight, especially 15 to 40% by weight, more specifically 15 to 35% by weight or 15 to 30% by weight, based on the total amount of monomers M, of α-methylene-γ-butyrolactone as a monomer M1, wherein at least 90 mol-%, in particular at least 95 mol-%, especially at least 95 mol-% or 100 mol-% of the carbon atoms of α-methylene-γ-butyrolactone are of biological origin;
ii. 30 to 80% by weight, in particular 35 to 75% by weight, especially 40 to 75% by weight, based on the total amount of monomers M, of monomers M2 which are a mixture of isobutyl acrylate with at least one C₂-C₁₀ alkyl acrylate, which is different from isobutyl acrylate, such as n-butyl acrylate, isoamyl acrylate, 2-methylbutyl acrylate, 2-octyl acrylate and 2-ethylhexyl acrylate, wherein at least the carbon atoms of the isobutyl groups in isobutyl acrylate are of biological origin, particularly the content of bio-carbon of isobutyl methacrylate is at least 54 mol-% in particular at least 57 mol-%;
iii. 1 to 35% by weight, in particular 1.5 to 30% by weight, especially 2 to 25% by weight, based on the total amount of monomers M, of a monomer M3, which is selected from methyl methacrylate, styrene and combinations thereof;
iv. 0.05 to 5% by weight, in particular 0.1 to 4% by weight, especially 0.5 to 3% by weight, based on the total amount of monomers M, of one or more monoethylenically unsaturated monomers M4, which is selected from monoethylenically unsaturated monomers having an acidic group;
v. 0 to 9.95% by weight, in particular 0.05 to 5% by weight, especially 0.1 to 4% by weight, based on the total weight of the monomers M, of one or more non-ionic monomers M5 having a solubility in deionized water at 20° C. and 1 bar of at least 60 g/L,
vi. 0 to 1% by weight, especially 0 to 0.5% by weight, of one or more monomers M7, based on the total weight of the monomers M;
where the total amount of monomers M1 and M3 is in the range from 5 to 70% by weight, in particular in the range from 10 to 65% by weight, especially in the range of 15 to 60% by weight, based on the total amount of ethylenically unsaturated monomers M, and where the total amount of monomers M1, M2 and M3 is at least 85% by weight, in particular at least 90% by weight, especially at least 95% by weight, based on the total amount of ethylenically unsaturated monomers M.

Preferably, the particles of the copolymer contained in the polymer latex have a Z-average particle diameter, as determined by quasi-elastic light scattering (QELS), in the range from 50 to 500 nm, in particular in the range from 60 to 350 nm. The particle size distribution of the copolymer particles contained in the polymer latex may be monomodal or almost monomodal, which means that the distribution function of the particle size has a single maximum and no particular shoulder. The particle size distribution of the copolymer particles contained in the polymer latex may also be polymodal or almost polymodal, which means that the distribution function of the particle size has at least two distinct maxima or at last one maximum and at least a pronounced shoulder.

If not stated otherwise, the size of the particles as well as the distribution of particle size is determined by quasielastic light scattering (QELS), also known as dynamic light scattering (DLS). The measurement method is described in the ISO 13321:1996 standard. The determination can be carried out using a High-Performance Particle Sizer (HPPS). For this purpose, a sample of the aqueous polymer latex will be diluted and the dilution will be analyzed. In the context of QELS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the polymer latex to water or an aqueous solution of a surfactant in order to avoid flocculation. Usually, dilution is performed by using a 0.1% by weight aqueous solution of a non-ionic emulsifier, e.g. an ethoxylated C16/C18 alkanol (degree of ethoxylation of 18), as a diluent. Measurement configuration: HPPS from Malvern, automated, with continuous-flow cuvette and Gilson autosampler. Parameters: measurement temperature 20.0° C.; measurement time 120 seconds (6 cycles each of 20 s); scattering angle 173°; wavelength laser 633 nm (HeNe); refractive index of medium 1.332 (aqueous); viscosity 0.9546 mPa·s. The measurement gives an average value of the second order cumulant analysis (mean of fits), i.e. Z average. The “mean of fits” is an average, intensity-weighted hydrodynamic particle diameter in nm.

The hydrodynamic particle diameter can also be determined by Hydrodynamic Chromatography fractionation (HDC), as for example described by H. Wiese, “Characterization of Aqueous Polymer Dispersions” in Polymer Dispersions and Their Industrial Applications (Wiley-VCH, 2002), pp. 41-73. For further details, reference is made to the examples and the description below.

The copolymer contained in the polymer particles may form a single phase or it may form different phases, if the polymer particles contain different copolymers, which differ with regard to their monomer composition. Preferably, the polymer particles contained in the aqueous polymer latex of the present invention comprise a polymer phase, which has a glass transition temperature Tg which does not exceed 50° C., in particular is at most 40° C., preferably in the range from −25 to +50° C., especially in the range from −20 to +40° C.

The glass transition temperatures as referred to herein are the actual glass transition temperatures. The actual glass transition temperature can be determined experimentally by the differential scanning calorimetry (DSC) method according to ISO 11357-2:2013, preferably with sample preparation according to ISO 16805:2003.

The actual glass transition temperature depends from the monomer compositions forming the polymer, and, therefore, a theoretical glass transition temperature can be calculated from the monomer composition used in the emulsion polymerization. The theoretical glass transition temperatures are usually calculated from the monomer composition by the Fox equation:

$$1 / {Tg}^{t} = {x}_{a} / {Tg}_{a} + {x}_{b} / {Tg}_{b} + … . {x}_{n} / {Tg}_{n} ,$$

In this equation xₐ, x_{b}, . . . xₙ are the mass fractions of the monomers a, b, . . . n and Tgₐ, Tg_{b}, . . . Tgₙ are the actual glass transition temperatures in Kelvin of the homopolymers synthesized from only one of the monomers 1, 2, . . . n at a time. The Fox equation is described by T. G. Fox in Bull. Am. Phys. Soc. 1956, 1, page 123 and as well as in Ullmann's Encyclopädie der technischen Chemie [Ullmann's Encyclopedia of Industrial Chemistry], vol. 19, p. 18, 4th ed., Verlag Chemie, Weinheim, 1980. The actual Tg values for the homopolymers of most monomers are known and listed, for example, in Ullmann's Encyclopädie der technischen Chemie [Ullmann's Encyclopedia of Industrial Chemistry], 5th ed., vol. A21, p. 169, Verlag Chemie, Weinheim, 1992. Further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, 3rd Ed. J. Wiley, New York 1989 and 4th Ed. J. Wiley, New York 2004.

Usually, the theoretical glass temperature Tg^{t} calculated according to Fox as described herein and the experimentally determined glass transition temperature as described herein are similar or even same and do not deviate from each other by more than 5 K, in particular they deviate not more than 2 K. Accordingly, both the actual and the theoretical glass transition temperatures of the polymer phases (1) and (2) can be adjusted by choosing proper monomers Ma, Mb . . . Mn and their mass fractions xₐ, x_{b}, . . . xₙ in the monomer composition so to arrive at the desired glass transition temperature Tg(1) and Tg(2), respectively. It is common knowledge for a skilled person to choose the proper amounts of monomers Ma, Mb . . . Mn for obtaining a copolymer and/or copolymer phase with the desired glass transition temperature.

Preferably, the aqueous polymer latices of the present invention have a pH of at least pH 3, e.g. in the range of pH 3 to pH 11.5.

The aqueous polymer dispersions of the present invention generally have solids contents in the range of 30 to 75% by weight, in particular in the range of 40 to 65% by weight, preferably in the range of 45 to 60% by weight. The solids content describes the proportion of nonvolatile fractions. The solids content of a dispersion is determined by means of a balance with infrared moisture analysis. In this determination, a quantity of polymer dispersion is introduced into the instrument, heated to 140° C. and subsequently held at that temperature. As soon as the average decrease in weight falls below 1 mg within 140 seconds, the measurement procedure is ended. The ratio of weight after drying to original mass introduced gives the solids content of the polymer dispersion. The total solids content of the formulation is determined arithmetically from the amounts of the substances added and from their solids contents and concentrations.

The polymer dispersions may contain a crosslinking agent for achieving post-crosslinking of the polymer latex particles, if the polymer in the polymer latex has functional groups which are complementary to the functional groups of the crosslinking agent. In this context, the term “complementary” is understood that the functional groups of the latex and the functional groups of the crosslinking agent are susceptible to undergo a chemical reaction which forms a chemical bond between the atoms of the respective functional groups. Typically, the crosslinking agent has at least two functional groups complementary to the functional groups of the polymer of the polymer latex. Examples of suitable crosslinking agents are described below.

Besides the polymer and the optional crosslinking agent, the aqueous polymer dispersions of the present invention may contain further ingredients conventionally present in aqueous polymer dispersions. These further ingredients are, for example, surface active compounds, such as emulsifiers und protective colloids, in particular those used in the production of the polymer latex, further defoamers and the like. Further ingredients may also be acids, bases, buffers, decomposition products from the polymerization reaction, deodorizing compounds, and chain transfer agents. Furthermore, the polymer latex may contain biocides for avoiding microbial spoilage. The amount of the respective individual component will typically not exceed 1.5 wt %, based on the total weight of the polymer dispersion. The total amount of these stated components will typically not exceed 5 wt %, based on the total weight of the polymer latex.

Preferably, the amount of volatile organic matter, i.e. the content of organic compounds with boiling points up to 250° C. under standard conditions (101,325 kPa) as determined by ISO 17895:2005 via gas-chromatography is less than 0.5% by weight, in particular less than 0.2% by weight, based on the total weight of the polymer latex.

Besides the polymer, the aqueous polymer latex also contains an aqueous phase, wherein the polymer particles of the polymer latex are dispersed. The aqueous phase, also termed serum, consists essentially of water and any water-soluble further ingredients. The total concentration of any further ingredient will typically not exceed 10 wt %, in particular 8% by weight, based on the total weight of the aqueous phase.

The aqueous polymer latex of the present invention can be prepared by any method for preparing an aqueous dispersion of a polymer made of polymerized monomers M. In particular, aqueous polymer latices of the present invention are prepared by an aqueous emulsion polymerization, in particular by a free radical aqueous emulsion polymerization of the monomers M. The term “free radical aqueous emulsion polymerization” means that the polymerization of the monomers M is initiated by radicals formed by the decay of a polymerization initiator, whereby free radicals are formed in the polymerization mixture. It is therefore also termed “radically initiated emulsion polymerization”. The procedure for radically initiated emulsion polymerizations of monomers in an aqueous medium has been extensively described and is therefore sufficiently familiar to the skilled person [cf. in this regard Emulsion Polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422; and Dispersionen synthetischer Hochpolymerer, F. Hölscher, Springer-Verlag, Berlin (1969)]. Typical procedures for aqueous emulsion polymerization of ethylenically unsaturated monomers are also described in the patent literature discussed in the introductory part of this patent application.

The radically initiated aqueous emulsion polymerization is typically carried out by emulsifying the ethylenically unsaturated monomers in the aqueous medium which forms the aqueous phase, typically by use of surface active compounds, such as emulsifiers and/or protective colloids, and polymerizing this system using at least one initiator which decays by formation of radicals and thereby initiates the chain growth addition polymerization of the ethylenically unsaturated monomers M. The preparation of an aqueous polymer dispersion in accordance with the present invention may differ from this general procedure only in the specific use of the aforementioned monomers M1 to M8. It will be appreciated here that the process shall, for the purposes of the present specification, also encompass the seed, staged, one-shot, and gradient regimes which are familiar to the skilled person.

The free-radically initiated aqueous emulsion polymerization is triggered by means of a free-radical polymerization initiator (free-radical initiator). These may, in principle, be peroxides or azo compounds. Of course, redox initiator systems are also useful. Peroxides used may, in principle, be inorganic peroxides such as hydrogen peroxide or peroxodisulfates such as the mono- or di-alkali metal or ammonium salts of peroxodisulfuric acid, for example the mono- and disodium, -potassium or ammonium salts, or organic peroxides such as alkyl hydroperoxides, for example tert-butyl hydroperoxide, p-menthyl hydroperoxide or cumyl hydroperoxide and also dialkyl or diaryl peroxides such as di-tert-butyl or di-cumyl peroxide. Azo compounds used are essentially 2,2′-azobis(isobutyronitrile), 2,2′-azobis(2,4-dimethylvaleronitrile) and 2,2′-azobis(amidinopropyl) dihydrochloride (AIBA, corresponds to V-50 from Wako Chemicals). Suitable oxidizing agents for redox initiator systems are essentially the peroxides specified above. Corresponding reducing agents which may be used are sulfur compounds with a low oxidation state such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols such as dihydroxymaleic acid, benzoin and/or ascorbic acid, and reducing saccharides such as sorbose, glucose, fructose and/or dihydroxyacetone.

Preferred free-radical initiators are inorganic peroxides, especially peroxodisulfates.

In general, the amount of the free-radical initiator used, based on the total amount of monomers M, is 0.05 to 2 pphm, preferably 0.1 to 1 pphm, based on the total amount of monomers M.

The amount of free-radical initiator required for the emulsion polymerization of monomers M can be initially charged in the polymerization vessel completely. However, it is also possible to charge none of or merely a portion of the free-radical initiator, for example not more than 30% by weight, especially not more than 20% by weight, based on the total amount of the free-radical initiator and then to add any remaining amount of free-radical initiator to the free-radical polymerization reaction under polymerization conditions. Preferably, at least 70%, in particular at least 80%, especially at least 90% or the total amount of the polymerization initiator are fed to the free-radical polymerization reaction under polymerization conditions. Feeding of the monomers M may be done according to the consumption, batch-wise in one or more portions or continuously with constant or varying flow rates during the free-radical emulsion polymerization of the monomers M.

Generally, the term “polymerization conditions” is understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, polymerization temperature and polymerization pressure are selected, such that a sufficient amount of initiating radicals is always present to initiate or to maintain the polymerization reaction.

Preferably, the radical emulsion polymerization of the monomers M is performed by a so-called feed process (also termed monomer feed method), which means that at least 80%, in particular at least 90% or the total amount of the monomers M to be polymerized are metered to the polymerization reaction under polymerization conditions during a metering period P. Addition may be done in portions and preferably continuously with constant or varying feed rate. The duration of the period P may depend from the production equipment and may vary from e.g. 20 minutes to 12 h. Frequently, the duration of the period P will be in the range from 0.5 h to 8 h, especially from 1 h to 6 h. In a multistep emulsion polymerization step, the total duration of all steps is typically in the above ranges. The duration of the individual steps is typically shorter. Preferably, at least 70%, in particular at least 80%, especially at least 90% or the total amount of the polymerization initiator is introduced into emulsion polymerization in parallel to the addition of the monomers.

The aqueous radical emulsion polymerization is usually performed in the presence of one or more suitable surfactants. These surfactants typically comprise emulsifiers and provide micelles, in which the polymerization occurs, and which serve to stabilize the monomer droplets during aqueous emulsion polymerization and also growing polymer particles. The surfactants used in the emulsion polymerization are usually not separated from the polymer dispersion, but remain in the aqueous polymer dispersion obtainable by the emulsion polymerization of the monomers M.

The surfactant may be selected from emulsifiers and protective colloids. Protective colloids, as opposed to emulsifiers, are understood to mean polymeric compounds having molecular weights above 2000 Daltons, whereas emulsifiers typically have lower molecular weights. The surfactants may be anionic or nonionic or mixtures of non-ionic and anionic surfactants.

Anionic surfactants usually bear at least one anionic group which is typically selected from phosphate, phosphonate, sulfate and sulfonate groups. The anionic surfactants which bear at least one anionic group are typically used in the form of their alkali metal salts, especially of their sodium salts or in the form of their ammonium salts.

Preferred anionic surfactants are anionic emulsifiers, in particular those which bear at least one sulfate or sulfonate group. Likewise, anionic emulsifiers which bear at least one phosphate or phosphonate group may be used, either as sole anionic emulsifiers or in combination with one or more anionic emulsifiers which bear at least one sulfate or sulfonate group.

Examples of anionic emulsifiers which bear at least one sulfate or sulfonate group, are, for example,
the salts, especially the alkali metal and ammonium salts, of alkyl sulfates, especially of C₈-C₂₂-alkyl sulfates,
the salts, especially the alkali metal and ammonium salts, of sulfuric monoesters of ethoxylated alkanols, especially of sulfuric monoesters of ethoxylated C₈-C₂₂-alkanols, preferably having an ethoxylation level (EO level) in the range from 2 to 40,
the salts, especially the alkali metal and ammonium salts, of alkylsulfonic acids, especially of C₈-C₂₂-alkylsulfonic acids,
the salts, especially the alkali metal and ammonium salts, of dialkyl esters, especially di-C₄-C₁₈-alkyl esters of sulfosuccinic acid,
the salts, especially the alkali metal and ammonium salts, of alkylbenzenesulfonic acids, especially of C₄-C₂₂-alkylbenzenesulfonic acids, and
the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The latter are common knowledge, for example from U.S. Pat. No. 4,269,749, and are commercially available, for example as Dowfax® 2A1 (Dow Chemical Company),
surfactants, which have a polymerizable ethylenically unsaturated double bond as described herein, e.g. the compounds of the formulae (I)-(IV), where X and Y, respectively, are SO₃⁻ or O—SO₃⁻.

Examples of anionic emulsifiers which bear a phosphate or phosphonate group, include, but are not limited to the following salts are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of alkylphosphonic acids, especially C₈-C₂₂-alkylphosphonic acids and
the salts, especially the alkali metal and ammonium salts, of alkylbenzenephosphonic acids, especially C₄-C₂₂-alkylbenzenephosphonic acids.
surfactants, which have a polymerizable ethylenically unsaturated double bond as described herein, e.g. the compounds of the formulae (I)-(IV), where X and Y, respectively, are HPO₃⁻, PO₃², O—HPO₃⁻ or O—PO₃².

Anionic emulsifiers may also comprise emulsifiers, which have a polymerizable double bond, e.g. the emulsifiers of the formulae (I) to (IV) and the salts thereof, in particular the alkalimetal salts or ammonium salts thereof:

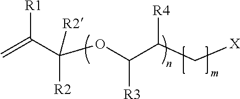

In formula (I), R¹ is H, C₁-C₂₀-alkyl, C₅-C₁₀-cycloalkyl, phenyl optionally substituted with C₁-C₂₀-alkyl, R² and R^{2′} are both H or together are 0, R³ and R⁴ are H or methyl, m is 0 or 1, n is an integer from 1-100 and X is SO₃⁻, O—SO₃⁻, O—HPO₃ or O—P₃²⁻.

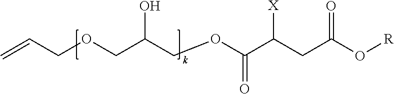

In formula (II), R is H, C₁-C₂₀-alkyl, C₅-C₁₀-cycloalkyl, phenyl optionally substituted with C₁-C₂₀-alkyl, k is 0 or 1 and X is SO₃⁻, O—SO₃⁻, O—HPO₃ or O—P₃²⁻.

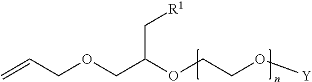

In formula (III), R¹ is H, C₁-C₂₀-alkyl, O—C₁-C₂₀-alkyl, C₅-C₁₀-cycloalkyl, O—C₅-C₁₀-cycloalkyl, O-phenyl optionally substituted with C₁-C₂₀-alkyl, n is an integer from 1-100 and Y is SO₃⁻, HPO₃⁻ or PO₃²⁻.

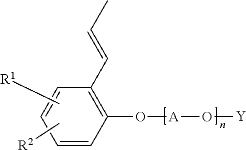

In formula (IV), R¹ is H, C₁-C₂₀-alkyl or 1-phenylethyl, R² is H, C₁-C₂₀-alkyl or 1-phenylethyl, A is C₂-C₄-alkanediyl, such as 1,2-ethanediyl, 1,2-propanediyl, 1,2-butanediyl or 1,4-butanediyl, n is an integer from 1-100 and Y is SO₃, HPO₃ or PO₃²⁻.

Particular embodiments of the copolymerizable emulsifiers of the formula (I) are referred to as sulfate esters or phosphate esters of polyethylene glycol monoacrylates. Particular embodiments of the copolymerizable emulsifiers of the formula (I) may likewise also be referred to as phosphonate esters of polyethylene glycol monoacrylates, or allyl ether sulfates. Commercially available co-polymerizable emulsifiers of the formula (I) are Maxemul® emulsifiers, Sipomer® PAM emulsifiers, Latemul® PD, and ADEKA Reasoap® PP-70.

Particular embodiments of the copolymerizable emulsifiers of the formula (II) are also referred to as alkyl allyl sulfosuccinates. Commercially available copolymerizable emulsifiers of the formula (II) is Trem® LF40.

Particular embodiments of the copolymerizable emulsifiers of the formula (III) are also referred to as branched unsaturated. Commercially available copolymerizable emulsifiers of the formula (III) are Adeka® Reasoap emulsifiers and Hitenol® KH.

Particular embodiments of the copolymerizable emulsifiers of the formula (IV) are also referred to as polyoxyethylene alkylphenyl ether sulfate and polyoxyethylene mono- or distyrylphenyl ether sulfate. Commercially available copolymerizable emulsifiers of the formula (IV) are Hitenol® BC and Hitenol® AR emulsifiers.

Further suitable anionic surfactants can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 192-208.

Preferably, the surfactant comprises at least one anionic emulsifier which bears at least one sulfate or sulfonate group. The at least one anionic emulsifier which bears at least one sulfate or sulfonate group, may be the sole type of anionic emulsifiers. However, mixtures of at least one anionic emulsifier which bears at least one sulfate or sulfonate group and at least one anionic emulsifier which bears at least one phosphate or phosphonate group may also be used. In such mixtures, the amount of the at least one anionic emulsifier which bears at least one sulfate or sulfonate group is preferably at least 50% by weight, based on the total weight of anionic surfactants used in the process of the present invention. In particular, the amount of anionic emulsifiers which bear at least one phosphate or phosphonate group does not exceed 20% by weight, based on the total weight of anionic surfactants used in the process of the present invention.

Preferred anionic surfactants are anionic emulsifiers which are selected from the following groups, including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of sulfuric monoesters of ethoxylated alkylphenols, especially of sulfuric monoesters of ethoxylated C₄-C₁₈-alkylphenols (EO level preferably 3 to 40),
of alkylbenzenesulfonic acids, especially of C₄-C₂₂-alkylbenzenesulfonic acids, and
of mono- or disulfonated, alkyl-substituted diphenyl ethers, for example of bis(phenylsulfonic acid) ethers bearing a C₄-C₂₄-alkyl group on one or both aromatic rings.
polymerizable emulsifiers of the formula (III).

Particular preference is given to anionic emulsifiers which are selected from the following groups including mixtures thereof:
the salts, especially the alkali metal and ammonium salts, of alkyl sulfates, especially of C₈-C₂₂-alkyl sulfates,
the salts, especially the alkali metal salts, of sulfuric monoesters of ethoxylated alkanols, especially of sulfuric monoesters of ethoxylated C₈-C₂₂-alkanols, preferably having an ethoxylation level (EO level) in the range from 2 to 40,
of mono- or disulfonated, alkyl-substituted diphenyl ethers, for example of bis(phenylsulfonic acid) ethers bearing a C₄-C₂₄-alkyl group on one or both aromatic rings
polymerizable emulsifiers of the formula (III), where Y is SO₃.

As well as the aforementioned anionic surfactants, the surfactant may also comprise one or more nonionic surface-active substances which are especially selected from nonionic emulsifiers. Suitable nonionic emulsifiers are e.g. araliphatic or aliphatic nonionic emulsifiers, for example ethoxylated mono-, di- and trialkylphenols (EO level: 3 to 50, alkyl radical: C₄-C₁₀), ethoxylates of long-chain alcohols (EO level: 3 to 100, alkyl radical: C₈-C₃₆), and polyethylene oxide/polypropylene oxide homo- and copolymers. These may comprise the alkylene oxide units copolymerized in random distribution or in the form of blocks. Very suitable examples are the EO/PO block copolymers. Preference is given to ethoxylates of long-chain alkanols, in particular to those, where the alkyl radical C₈-C₃₀ having a mean ethoxylation level of 5 to 100 and, among these, particular preference to those having a linear C₁₂-C₂₀ alkyl radical and a mean ethoxylation level of 10 to 50 and also to ethoxylated monoalkylphenols.

The surfactants used in the process of the present invention will usually comprise not more than 30% by weight, especially not more than 20% by weight, of nonionic surfactants based on the total amount of surfactants used in the process of the present invention and especially do not comprise any nonionic surfactant. Combinations of at least one anionic surfactant and at least non-ionic surfactant may also be used. In this case, the weight ratio of the total amount of anionic surfactant to the total amount of non-ionic surfactant is in the range of 99:1 to 70:30, in particular 98:2 to 75:25, especially in the range 95:5 to 80:20.

Preferably, the surfactant will be used in such an amount that the amount of surfactant is in the range from 0.2 to 5% by weight, especially in the range from 0.3 to 4.5% by weight, based on the monomers M to be polymerized. In a multistep emulsion step emulsion polymerization, the surfactant will be used in such an amount that the amount of surfactant is usually in the range from 0.2 to 5% by weight, especially in the range from 0.3 to 4.5% by weight, based on the total amount of monomers polymerized in the respective steps.

Preferably, the major portion, i.e. at least 80% of the surfactant used, is added to the emulsion polymerization in parallel to the addition of the monomers. In particular, the monomers are added as an aqueous emulsion to the polymerization reaction which contains at least 80% of the surfactant used in the emulsion polymerization.

It has been found advantageous to perform the free-radical emulsion polymerization of the monomers M in the presence of a seed latex. A seed latex is a polymer latex which is present in the aqueous polymerization medium before the polymerization of monomers M is started. The seed latex may help to better adjust the particle size or the final polymer latex obtained in the free-radical emulsion polymerization of the invention.

Principally, every polymer latex may serve as a seed latex. For the purpose of the invention, preference is given to seed latices, where the particle size of the polymer particles is comparatively small. In particular, the Z average particle diameter of the polymer particles of the seed latex, as determined by dynamic light scattering (DLS) at 20° C. (see below), is preferably in the range from 10 to 80 nm, in particular from 10 to 50 nm. Preferably, the polymer particles of the seed latex is made of ethylenically unsaturated monomers which comprise at least 95% by weight, based on the total weight of the monomers forming the seed latex, of one or more monomers selected from the group consisting of C₂-C₁₀-alkyl esters of acrylic acid, in particular ethyl acrylate, n-butyl acrylate, n-hexyl acrylate, n-octyl acrylate, 2-ethyl-hexylacrylate, C₁-C₄-alkyl methacrylates such as methyl methacrylate, monoethylenically unsaturated nitriles, such as acrylonitrile and vinylaromatic monomers as defined above such as styrene and mixtures thereof. In particular, the polymer particles of the seed latex is made of ethylenically unsaturated monomers which comprise at least 95% by weight, based on the total weight of the monomers forming the seed latex, of one or more monomers selected from the group consisting of C₁-C₄-alkyl methacrylates such as methyl methacrylate, monoethylenically unsaturated nitriles, such as acrylonitrile and vinylaromatic monomers as defined above such as styrene and mixtures thereof.

For this, the seed latex is usually charged into the polymerization vessel before the polymerization of the monomers M is started. In particular, the seed latex is charged into the polymerization vessel followed by establishing the polymerization conditions, e.g. by heating the mixture to polymerization temperature. It may be beneficial to charge at least a portion of the free-radical initiator into the polymerization vessel before the addition of the monomers M is started. However, it is also possible to add the monomers M and the free-radical polymerization initiator in parallel to the polymerization vessel.

The amount of seed latex, calculated as solids, may frequently be in the range of 0.01 to 10% by weight, preferably in the range of 0.05 to 5% by weight, in particular in the range of 0.05 to 3% by weight, based on the total weight of the monomers in the monomer composition M to be polymerized.

The free-radical aqueous emulsion polymerization of the invention can be carried out at temperatures in the range from 0 to 170° C. Temperatures employed are generally in the range from 50 to 120° C., frequently 60 to 120° C. and often 70 to 110° C. The free-radical aqueous emulsion polymerization of the invention can be conducted at a pressure of less than, equal to or greater than 1 atm (atmospheric pressure), and so the polymerization temperature may exceed 100° C. and may be up to 170° C. Polymerization of the monomers is normally performed at ambient pressure, but it may also be performed under elevated pressure. In this case, the pressure may assume values of 1.2, 1.5, 2, 5, 10, 15 bar (absolute) or even higher values. If emulsion polymerizations are conducted under reduced pressure, pressures of 950 mbar, frequently of 900 mbar and often 850 mbar (absolute) are established. Advantageously, the free-radical aqueous emulsion polymerization of the invention is conducted at ambient pressure (about 1 atm) with exclusion of oxygen, for example under an inert gas atmosphere, for example under nitrogen or argon.

The process for producing the polymer latex of the present invention may be a single stage polymerization or a multistage emulsion polymerization. In a single stage polymerization, the overall composition of the monomers M, which are fed to the polymerization reaction under polymerization conditions, remains the same or almost the same, while in a multistage emulsion polymerization the overall composition of the monomers M, which are fed to the polymerization reaction under polymerization conditions, is altered at least once, in particular such that the theoretical glass transition temperature of the resulting polymer formed in one stage differs from the theoretical glass transition temperature of the resulting polymer formed in another stage by at least 10° C., in particular by at least 20° C. or at least 40° C.

In a particular group of embodiments, the process of the invention is performed as a 2-stage emulsion polymerization, i.e. the composition of the monomers, which are fed to the polymerization reaction under polymerization conditions, is amended once, or as a 3- or 4-stage emulsion polymerization, i.e. the composition of the monomers, which are fed to the polymerization reaction under polymerization conditions, is amended twice or trice.

The polymerization of the monomers M can optionally be conducted in the presence of chain transfer agents. Chain transfer agents are understood to mean compounds that transfer free radicals, and which reduce the molecular weight of the growing chain and/or which control chain growth in the polymerization. Examples of chain transfer agents are aliphatic and/or araliphatic halogen compounds, for example n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, for example ethanethiol, n-propanethiol, 2-propanethiol, n-butanethiol, 2-butanethiol, 2-methyl-2-propanethiol, n-pentanethiol, 2 pentanethiol, 3-pentanethiol, 2-methyl-2-butanethiol, 3-methyl-2-butanethiol, n hexanethiol, 2-hexanethiol, 3-hexanethiol, 2-methyl-2-pentanethiol, 3-methyl-2 pentanethiol, 4-methyl-2-pentanethiol, 2-methyl-3-pentanethiol, 3-methyl-3 pentanethiol, 2-ethylbutanethiol, 2-ethyl-2-butanethiol, n-heptanethiol and the isomeric compounds thereof, n-octanethiol and the isomeric compounds thereof, n nonanethiol and the isomeric compounds thereof, n-decanethiol and the isomeric compounds thereof, n-undecanethiol and the isomeric compounds thereof, n dodecanethiol and the isomeric compounds thereof, n-tridecanethiol and isomeric compounds thereof, substituted thiols, for example 2-hydroxyethanethiol, aromatic thiols such as benzenethiol, ortho-, meta- or para-methylbenzenethiol, alkyl esters of mercaptoacetic acid (thioglycolic acid), such as 2-ethylhexyl thioglycolate, alkyl esters of mercaptopropionic acid, such as octyl mercapto propionate, and also further sulfur compounds described in Polymer Handbook, 3rd edition, 1989, J. Brandrup and E. H. Immergut, John Wiley & Sons, section II, pages 133 to 141, but also aliphatic and/or aromatic aldehydes, such as acetaldehyde, propionaldehyde and/or benzaldehyde, unsaturated fatty acids, such as oleic acid, dienes having nonconjugated double bonds, such as divinylmethane or vinylcyclohexane, or hydrocarbons having readily abstractable hydrogen atoms, for example toluene.

Alternatively, it is possible to use mixtures of the aforementioned chain transfer agents that do not disrupt one another. The total amount of chain transfer agents optionally used in the process of the invention, based on the total amount of monomers M, will generally not exceed 2% by weight, in particular 1% by weight. However, it is possible, that during a certain period of the polymerization reaction the amount of chain transfer agent added to the polymerization reaction may exceed the value of 2% by weight and may be as high as 8% by weight, in particular at most 4% by weight, based on the total amount of monomers M added to the polymerization reaction during said period.

It is frequently advantageous, when the aqueous polymer dispersion obtained on completion of polymerization of the monomers M is subjected to an after-treatment to reduce the residual monomer content. This after-treatment is effected either chemically, for example by completing the polymerization reaction using a more effective free-radical initiator system (known as postpolymerization), and/or physically, for example by stripping the aqueous polymer dispersion with steam or inert gas. Corresponding chemical and physical methods are familiar to those skilled in the art—see, for example, EP-A 771328, DE-A 19624299, DE-A 19621027, DE-A 19741184, DE-A 19741187, DE-A 19805122, DE-A 19828183, DE-A 19839199, DE-A 19840586 and DE-A 19847115. The combination of chemical and physical after-treatment has the advantage that it removes not only the unconverted ethylenically unsaturated monomers, but also other disruptive volatile organic constituents (VOCs) from the aqueous polymer dispersion.

As the polymer contained in the aqueous polymer dispersion may contain acidic groups from the monomers M4 and optionally from the polymerization initiator, the aqueous polymer dispersion obtained by the process of the invention is frequently neutralized prior to formulating it as a coating composition. The neutralization of acid groups of the polymer is achieved by neutralizing agents known to the skilled of the art after polymerization and/or during the polymerization. For example, the neutralizing agent may be added in a joint feed with the monomers to be polymerized or in a separate feed. Suitable neutralizing agents include organic amines, alkali hydroxides, ammonium hydroxides. In particular, neutralization is achieved by using ammonia or alkali hydroxides such as sodium hydroxide or potassium hydroxide.

Furthermore, it might be suitable to formulate the polymer latex of the invention with a post-curing agent. Ideally, such a post-curing agent, also termed as post-crosslinking agent, will result in a crosslinking reaction during and/or after film formation by forming coordinative or covalent bonds with reactive sites on the surface of the polymer particles.

Crosslinking agents, which are suitable for providing post crosslinking, are for example compounds having at least two functional groups selected from oxazoline, amino, aldehyde, aminoxy, carbodiimide, aziridinyl, epoxy and hydrazide groups, derivatives or compounds bearing acetoacetyl groups. These crosslinkers react with reactive sites of the polymers of the polymer dispersion which bear complementary functional groups in the polymer, which are capable of forming a covalent bond with the crosslinker. Suitable systems are known to skilled persons.

As the polymers contained in the polymer dispersion of the invention bear carboxyl groups, post-crosslinking can be achieved by formulation of the polymer dispersion with one or more polycarbodiimides as described in U.S. Pat. Nos. 4,977,219, 5,047,588, 5,117,059, EP 0277361, EP 0507407, EP 0628582, U.S. Pat. No. 5,352,400, US 2011/0151128 and US 2011/0217471. It is assumed that crosslinking is based on the reaction of the carboxyl groups of the polymers with polycarbodiimides. The reaction typically results in covalent cross-links which are predominately based on N-acyl urea bounds (J. W. Taylor and D. R. Bassett, in E. J. Glass (Ed.), Technology for Waterborne Coatings, ACS Symposium Series 663, Am. Chem. Soc., Washington, D C, 1997, chapter 8, pages 137 to 163).

Likewise, as the polymer particles contained in the polymer dispersion of the present invention bear carboxyl groups stemming from monomers M4, a suitable post-curing agent may also be a water-soluble or water-dispersible polymer bearing oxazoline groups, e.g. the polymers as described in U.S. Pat. No. 5,300,602 and WO 2015/197662.

Post crosslinking can also be achieved by analogy to EP 1227116, which describes aqueous two-component coating compositions containing a binder polymer with carboxylic acid and hydroxyl functional groups and a polyfunctional crosslinker having functional groups selected from isocyanate, carbodiimide, aziridinyl and epoxy groups.

If the polymer in the polymer dispersion bears a keto group, e.g. by using a monomer M5c such as diacetone acrylamide (DAAM), post-crosslinking can be achieved by formulating the aqueous polymer dispersion with one or more dihydrazides, in particular aliphatic dicarboxylic acid such as adipic acid dihydrazide (ADDH) as described in U.S. Pat. No. 4,931,494, US 2006/247367 and US 2004/143058. These components react basically during and after film formation, although a certain extent of preliminary reaction can occur.

Other suitable agents of achieving post-curing include
epoxysilanes to crosslink carboxy groups in the polymer;
dialdehydes such as glyoxal to crosslink urea groups or acetoacetoxy groups, such as those derived from the monomers M5b and M5c, respectively, as defined herein, in particular ureido (meth)acrylate or acetoacetoxyethyl (meth)acrylate;
di- and/or polyamines to crosslink keto groups or epoxy groups such as those derived from the monomers M5c or M6b as defined herein; and
UV initiators such as benzophenones, including benzophenone, 4-methoxybenzophenone, 4-methylbenzophenone, 2,4,6-trimethylbenzophenone, acetophenones, such as 2-hydroxy-2,2-dimethylacetophenone, 2-phenyl-2,2-dimethylacetophenone, cycloalkylphenyl ketones, such as 1-benzoylcyclohexan-1-ol (=1-hydroxycyclhexylphenyl ketone) and benzoins and mixtures thereof, in particular liquid mixtures such as mixtures of 4-methylbenzophenone and benzophenone, mixtures of 2,4,6-trimethylbenzophenone and benzophenone and mixtures of 1-hydroxycyclhexylphenyl ketone and benzophenone.

Suitable systems are e.g. described in EP 355028, EP 441221, EP 0789724, U.S. Pat. Nos. 5,516,453 and 5,498,659 and/or commercially available, e.g. in case of UV initiators from Omnirad and IGM Resins (e.g. Esacure TZM, Esacure TZT, Omnirad 4MBZ).

The present invention also relates to waterborne coating compositions, which contain
a) a binder polymer in the form of the aqueous polymer latex as defined herein; and
b) at least one further ingredient, which is conventionally used in waterborne coating compositions and which is not a binder.

The waterborne coating compositions of the invention may be formulated as a clear coat or a as a paint. In the latter case, the waterborne coating compositions contain, in addition to the polymer latex, at least one of inorganic pigments and inorganic fillers. In particular, the waterborne coating compositions contain least one inorganic pigment, in particular at least one inorganic pigment which imparts a white shade or a color to the coating obtained when using the waterborne coating composition for coating substrates.

Pigments for the purposes of the present invention are virtually insoluble, finely dispersed, organic or preferably inorganic colorants as per the definition in German standard specification DIN 55944:2003-11. Examples of pigments are in particular inorganic pigments, such as white pigments like titanium dioxide (C.I. Pigment White 6), but also color pigments, e.g.
black pigments, such as iron oxide black (C.I. Pigment Black 11), iron manganese black, spinel black (C.I. Pigment Black 27), carbon black (C.I. Pigment Black 7);
color pigments, such as chromium oxide, chromium oxide hydrate green; chrome green (C.I. Pigment Green 48); cobalt green (C.I. Pigment Green 50); ultramarine green; cobalt blue (C.I. Pigment Blue 28 und 36); ultramarine blue, iron blue (C.I. Pigment Blue 27), manganese blue, ultramarine violet, cobalt violet, manganese violet, iron oxide read (C.I. Pigment Red 101); cadmium sulfoselenide (C.I. Pigment Red 108); molybdate read (C.I. Pigment Red 104); ultramarine read,
iron oxide brown, mixed brown, spinel- and Korundum phases (C.I. Pigment Brown 24, 29 und 31), chrome orange;
iron oxide yellow (C.I. Pigment Yellow 42); nickel titanium yellow (C.I. Pigment Yellow 53; C.I. Pigment Yellow 157 und 164); chrome titanium yellow; cadmium sulfide und cadmium zinc sulfide (C.I. Pigment Yellow 37 und 35); Chrome yellow (C.I. Pigment Yellow 34), zinc yellow, alkaline earth metal chromates; Naples yellow; bismuth vanadate (C.I. Pigment Yellow 184);
Interference pigments, such as metallic effect pigments based on coated metal platelets, pearl luster pigments based on mica platelets coated with metal oxide, and liquid crystal pigments.

The water-borne coating compositions may also contain one or more fillers. Examples of suitable fillers are in particular inorganic fillers, e. g. aluminosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide, etc. In the coating compositions of the invention, finely divided fillers are naturally preferred. The fillers may be used in the form of individual components. In practice, however, filler mixtures have been found to be particularly useful, for example calcium carbonate/kaolin, calcium carbonate/talc. Gloss paints generally comprise only small amounts of very finely divided fillers or do not comprise any fillers. Fillers also include flatting agents which significantly impair the gloss as desired. Flatting agents are generally transparent and may be either organic or inorganic. Examples of flatting agents are inorganic silicates, for example the Syloid® brands from W. R. Grace & Company and the Acematt® brands from Evonik GmbH. Organic flatting agents are obtainable, for example, from BYK-Chemie GmbH under the Ceraflour® brands and the Ceramat® brands, and from Deuteron GmbH under the Deuteron MK® brand.

The proportion of the pigments and fillers in the water-borne coating compositions can be described in a manner known per se via the pigment volume concentration (PVC). The PVC describes the ratio of the volume of pigments (VP) and fillers (VF) relative to the total volume, consisting of the volumes of binder (VB), pigments (VP) and fillers (VF) in a dried coating film in percent: PVC [%]=(VP+VF)×100/(VP+VF+VB).

If the water-borne coating compositions are formulated as a paint, they usually have a pigment volume concentration (PVC) of at least 5%, especially at least 10% and will typically not exceed 90%, in particular 85%. In a preferred group of embodiments, the PVC will not exceed a value of 60%, especially 50%, and is specifically in the range from 5 to 60% or 5 to 50%. However, the inventive effects of the polymer dispersions are also manifested in varnishes which typically have a pigment/filler content below 5% by weight, based on the varnish, and correspondingly have a PVC below 5%. In yet another group of embodiments, the PVC will be in the range of >60 to 90%, in particular in the range of 65 to 85%.

According to one group of embodiments, the water-borne coating compositions of the invention are designed as a paint containing white pigment—that is, they comprise at least one white pigment and optionally one or more fillers. As white pigment they include, in particular, titanium dioxide, preferably in the rutile form, optionally in combination with one or more fillers. With particular preference, the coating compositions of the invention comprise a white pigment, more particularly titanium dioxide, preferably in the rutile form, in combination with one or more fillers, such as chalk, talc or mixtures thereof, for example.

In another preferred group of embodiments, the water-borne coating compositions of the invention are designed as a clear-coat or as a wood-stain formulation. In contrast to paints, clear-coats are essentially devoid of pigments and fillers, while wood stains do not contain much fillers, i.e. they have a PVC of below 5%.

According to a particular group of embodiments, the present invention also relates to an waterborne coating composition (hereinafter also referred to as aqueous coating composition) comprising:
i) at least one aqueous polymer latex as defined above; and
ii) a titanium dioxide pigment.

According to a further particular group of embodiments, the present invention also relates to the use of the aqueous polymer latex as a binder in an aqueous coating composition containing a titanium dioxide pigment.

In the aforementioned embodiments the aqueous polymer latex is combined with a TiO₂ pigment slurry or paste. The TiO₂ concentration of an aqueous TiO₂ pigment slurry or paste used for preparing the aqueous coating composition will generally be in the range from 30% to 85% by weight, frequently 40% to 80% by weight and, based in each case on the total weight of the aqueous TiO₂ pigment slurry or paste. The titanium dioxide pigment used for preparing the aqueous dispersion of the pigment slurry or paste may be any TiO₂ pigment conventionally used in coating compositions, in particular in aqueous coating compositions. Frequently, a TiO₂ pigment is used wherein the TiO₂ particles are preferably in the rutile form. In another preferred embodiment the TiO₂ particles can also be coated e.g. with aluminum, silicon and zirconium compounds.

In general, the weight ratio of the polymer to the titanium dioxide pigment is in the range of ≥0.1:5.0 to ≤5.0:0.1; preferably the weight ratio of the polymer to the titanium dioxide pigment is in the range of ≥0.5:5.0 to ≤5.0:0.5; in particular more preferably the weight ratio of the polymer to the titanium dioxide pigment is in the range of ≥0.5:3.0 to ≤3.0:0.5 and in particular in the range of ≥0.5:1.5 to ≤1.5:0.5.

Preferably, the titanium dioxide pigment has an average primary particle size in the range of ≥0.1 μm to ≤0.5 μm, as determined by light scattering or by electron microscopy.

In general, the aqueous coating composition further comprises at least one additive selected from the group consisting of thickeners, defoamers, levelling agents, filming auxiliaries, biocides, wetting agents or dispersants, fillers and coalescing agents.

The aqueous coating composition can be simply prepared by mixing TiO₂ pigment powder or an aqueous slurry or paste of TiO₂ pigment with the aqueous polymer latex of the invention, preferably by applying shear to the mixture, e.g. by using a dissolver conventionally used for preparing water-borne paints. It will also be possible to prepare an aqueous slurry or paste of TiO₂ pigment and the aqueous polymer latex of the invention, which is then incorporated into or mixed with further polymer latex of the invention or with any other polymer latex binder.

The aqueous dispersion of the polymer composite may also be prepared by incorporating the aqueous polymer latex of the invention as a binder or co-binder in an aqueous base formulation of a paint, which already contains a TiO₂ pigment, e.g. by mixing the aqueous polymer latex of the invention with a pigment formulation that already contains further additives conventionally used in the paint formulation.

In order to stabilize the TiO₂ pigment particles in the aqueous pigment slurry or paste, the mixing may optionally be performed in the presence of additives conventionally used in aqueous pigment slurries or pigment pastes, such as dispersants. Suitable dispersants include but are not limited to, for example, polyphosphates such as sodium polyphosphates, potassium polyphosphates or ammonium polyphosphates, alkali metal salts and ammonium salts of acrylic acid homo- or copolymers or maleic anhydride polymers, polyphosphonates, such as sodium 1-hydroxyethane-1,1-diphosphonate, and naphthalenesulfonic salts, especially the sodium salts thereof.

The polymer concentration in the aqueous polymer latex used for preparing the aqueous dispersion of the polymer composite is generally in the range from 10% to 70% by weight, preferably 20% to 65% by weight and most preferably 30% to 60% by weight, based in each case on the total weight of the aqueous polymer latex.

In addition to the polymer latex of the present invention and a titanium dioxide pigment and an optional conventional binder, the aqueous coating compositions may contain one or more pigments different from the TiO₂ pigment and/or fillers as described above.

Preferably, the waterborne coating compositions comprise at least one aqueous polymer latex as defined herein, further comprises a rheology modifying agent. Suitable rheology modifying agents include associative thickener polymers and non-associative rheology modifiers. The aqueous liquid composition preferably comprises a thickening agent selected from the group consisting of associative thickeners and a non-associative thickener and combinations thereof.

Associative thickener polymers are well known and frequently described in the scientific literature, e.g. by E. J. Schaller et al., “Associative Thickeners” in Handbook of Coating Additives, Vol. 2 (Editor L. J. Calbo), Marcel Decker 192, pp. 105-164, J. Bieleman “PUR-Verdicker” in Additives for Coatings (Editor J. Bielemann), Wiley 2000, pp 50-58. NiSAT thickener polymers of the HEUR and HMPE type are also described in the patent literature, such as U.S. Pat. Nos. 4,079,028, 4,155,892, EP 61822, EP 307775, WO 96/31550, EP 612329, EP 1013264, EP 1541643, EP 1584331, EP 2184304, DE 4137247, DE 102004008015, DE 102004031786, US 2011/0166291 and WO 2012/052508. Apart from that, associative thickener polymers are commercially available.

The associative thickener polymers include anionic, acrylate type thickener polymers, so-called HASE polymers (hydrophobically modified polyacrylate thickeners), which are copolymers of acrylic acid and alkyl acrylate monomers, where the alkyl group of the alkyl acrylate may have from 6 to 24 carbon atoms. The associative thickener polymers also include non-ionic associative thickeners, so called NiSAT thickeners (non-ionic synthetic associative thickeners), which usually are linear or branched block copolymers having at least one interior hydrophilic moiety, in particular a polyether moiety, especially at least one polyethylene oxide moiety and two or more terminal hydrocarbon groups each having at least 4 carbon atoms, in particular from 4 to 24 carbon atoms, e.g. a linear or branched alkyl radical having 4 to 24 carbon atoms or alkyl substituted phenyl having 7 to 24 carbon atoms. NiSAT thickeners include the hydrophobically modified polyethylene oxide urethane rheology modifiers, also termed HEUR or PUR thickeners, and hydrophobically modified polyethyleneoxides, which are also termed HMPE.

The amount of the associative thickener polymer will depend on the desired viscosity profile and is frequently in the range from 0.05 to 2.5% by weight, in particular 0.1 to 2% by weight of thickener, and especially 0.2 to 2% by weight, based on the latex paint.

Suitable non-associative rheology modifiers are in particular cellulose-based thickeners, especially hydroxyethyl cellulose, but also thickeners based on acrylate emulsions (ASE). Amongst the non-associative rheology modifiers preference is given to non-associative cellulose based thickeners.

The total amount of the thickener polymer will depend on the desired viscosity profile and is frequently in the range from 0.05 to 6% by weight, in particular 0.1 to 5.5% by weight of thickener, and especially 0.15 to 5% by weight, based on the latex paint.

The aqueous coating compositions of the invention may also comprise customary auxiliaries. The customary auxiliaries will depend from the kind of the coating in a well-known manner and include but are not limited to:
wetting agents or dispersants,
filming auxiliaries, also termed coalescents,
leveling agents,
UV stabilizers,
biocides and
defoamers/de-aerators.

Suitable wetting agents or dispersants are, for example, sodium polyphosphates, potassium polyphosphates or ammonium polyphosphates, alkali metal salts and ammonium salts of acrylic acid copolymers or maleic anhydride copolymers, polyphosphonates, such as sodium 1-hydroxyethane-1,1-diphosphonate, and naphthalenesulfonic salts, especially the sodium salts thereof.

Suitable filming auxiliaries are solvents and plasticizers. Plasticizers, in contrast to solvents, have a low volatility and preferably have a boiling point at 1013 mbar of higher than 250° C., while solvents have a higher volatility than plasticizers and preferably have a boiling point at 1013 mbar of less than 250° C. Suitable filming auxiliaries are, for example, white spirit, pine oil, propylene glycol, ethylene glycol, butyl glycol, butyl glycol acetate, butyl glycol diacetate, butyl diglycol, butylcarbitol, 1-methoxy-2-propanol, 2,2,2-trimethyl-1,3-pentanediol monoisobutyrate (Texanol®) and the glycol ethers and esters, commercially available, for example, from BASF SE under the Solvenon® and Lusolvan® and Loxanol® names, and from Dow under the Dowanol® trade name. The amount is preferably <5% by weight and more preferably <1% by weight, based on the overall formulation. Formulation is also possible completely without filming auxiliaries. Frequently, the coating compositions do not require any filming auxiliaries.

Further suitable auxiliaries and components are e.g. described by J. Bieleman in “Additives for Coatings”, Whiley-VCH, Weinheim 2000; by T. C. Patton in “Paint Flow and Pigment Dispersions”, 2nd Edition, John Whiley & Sons 1978; and by M. Schwartz and R. Baumstark in “Water based Acrylates for Decorative Coatings”, Curt R. Vincentz Verlag, Hanover 2001.

Preferably, the waterborne coating composition does not contain more than 5% by weight of organic solvents, in particular not more than 1% by weight of organic solvents, based on the total weight of the waterborne coating composition. Here, the term “solvent” refers to organic liquid compounds, which have a boiling point at 1013 mbar of less than 250° C. In a preferred group of embodiments, the total amount of such organic solvents is not more than 0.5% by weight.

The waterborne coating compositions of the invention may also be formulated as a no VOC paint. In this case the concentration of volatile compounds in the coating composition is typically below 0.5% by weight, preferably below 0.1 wt.-%, more preferably below 0.05 wt.-%, based on the total amount of the waterborne coating composition. A volatile compound in terms of the invention is a compound, which has a boiling point at 1013 mbar of less than 250° C.

The waterborne coating compositions of the invention are particularly useful in architectural coatings, i.e. for coating exterior or interior parts of a building. In this case, the substrate may be a mineral substrate, such as plaster, gypsum, plasterboard or concrete, wood, wood-based materials, metal, wallpaper or plastic, such as PVC.

The waterborne coating compositions can be applied to substrates to be coated in a customary manner, for example by applying it with brushes or rollers, by spraying, by dipping, by rolling, or by bar coating to the desired substrate. Preferred applications are by brush and/or by roller.

Usually, the coating of substrates is effected in such a way that the substrate is first coated a waterborne coating composition of the invention, and then the thus obtained aqueous coating is subjected to a drying step, especially within the temperature range of ≥−10 and +50° C., advantageously ≥+5 and +40° C. and especially advantageously ≥+10 and +35° C.

The substrates coated with a waterborne coating composition of the invention have excellent hardness, good adhesion properties such as high dry and wet alkyd adhesion and intercoat adhesion, good opacity, good stain removal properties and low dirt pick-up.

### EXAMPLES

The invention is to be illustrated by following non-limiting examples:

### 1. Abbreviations

wt % % by weight

Here and in the following the terms “room temperature” and “ambient temperature” means a temperature in the range of 22-23° C.

### 2. Analytics of the Polymer Latices

### 2.1 Solids Content

The solids content was determined by drying a defined amount of the aqueous polymer dispersion (about 2 g) to constant weight in an aluminum crucible having an internal diameter of about 5 cm at 130° C. in a drying cabinet (2 hours). Two separate measurements were conducted. The value reported in the example is the mean of the two measurements.

### 2.2 Particle Diameter

If not stated otherwise, average particle diameter of the polymer latex was determined by dynamic light scattering (DLS) according to the ISO 13321:1996 standard as described herein above, using a Malvern HPPS.

### 2.3 Glass Transition Temperature Tg

The glass transition temperature was determined by the DSC method (Differential Scanning Calorimetry, 20 K/min, midpoint measurement) according to the ISO 11357-2:2013 standard as described herein above, by means of a DSC instrument (Q 2000 series from TA instruments).

### 2.4 pH Measurements

pH measurements were performed on reaction mixtures, using a pH meter.

### 3. Ingredients

The following components were used in the present examples:

| Common name/IUPAC | | |
|---|---|---|
| Name | Commercial name | Available from |
| Methyl methacrylate | Methyl methacrylate | BASF SE |
| α-Methylene-γ- | α-Methylene-γ- | BASF SE |
| butyrolactone | butyrolactone | |
| Isobutyl acrylate | Isobutyl acrylate | BASF SE |
| Acrylic acid | Acrylic acid | BASE SE |
| Acrylamide | Acrylamide | BASF SE |
| Polystyrene seed dispersion | Polystyrene seed | BASF SE |
| | dispersion | |
| Alkyldiphenyloxide | Dowfax ® 2A1 | Dow Chemicals |
| Disulfonate | | |
| C₁₃H₂₇O(CH₂CH₂O)xH | Lutensol ® TO 82 | BASF SE |
| Sodium persulfate | Sodium persulfate | Sigma Aldrich |
| t-Butylhydroperoxide | t-Butylhydroperoxide | BASF SE |
| Sodium | Rongalit ® C | Brueggemann |
| hydroxymethanesulfinate | | |
| Titanium Dioxide | Kronos 4311 | Kronos |
| | | Worldwide, Inc |
| Neutralizer containing 2- | AMP-95 | Angus Chemical |
| amino-2-methyl-1-propanol | | Company |
| Ammonium salt of a | Tamol 165 A | Dow |
| hydrophobic copolymer as | | |
| dispersant | | |
| Hyperbranched polymer | Foamstar 2420 | BASF SE |
| defoamer | | |
| Nonvolatile, non-ionic | Hydropalat WE 3320 | BASF SE |
| surfactant as surface | | |
| levelling and wetting agent | | |
| Non-ionic associative | Aquaflow ® NHS-310 | Ashland |
| thickener | | |
| Polymeric pigment | Ropaque Ultra E | Dow |
| Filler produced from | Minex 10 | Sibelco |
| nepheline syenite | | |
| Coalescing agent 2,2,4- | Texanol | Eastman |
| Trimethyl-1,3- | | |
| pentandiolmonoisobutyrat | | |
| Low odor coalescing agent | Optifilm 400 | Eastman |
| Biocide | Proxel AQ | Lonza |
| Fungicide | Polyphase 663 | Troy Corporation |
| Non-ionic associative | Rheolate CVS 10 | Elementis |
| thickener | | |
| Non-ionic associative | Acrysol RM 895 | Dow |
| thickener | | |
| Attapulgite clay | Attagel 50 | BASF SE |

Isobutyl acrylate can be prepared by analogy to the protocol for producing bio isoamyl acrylate by transesterification of ethyl acrylate with isobutanol described in WO 2022/018013. Isobutanol can be obtained by fermentation from carbohydrates with >98% biocarbon content.

α-Methylene-γ-butyrolactone can be prepared from itaconic acid by analogy to the biotechnological process described in PCT/EP2022077180. Itaconic acid is a commercial product having 100% biocarbon and is prepared from carbohydrates.

### 4. Preparation Examples

### 4.1 Binder Examples

### Inventive Example E1

Binder Based on a Polymer with α-methylene-γ-Butyrolactone and Isobutyl Acrylate

A reactor equipped with stirrer, temperature control, nitrogen inlet and several injection possibilities was charged with 244.3 g deionized water, 27.3 g polystyrene seed dispersion (33 wt %, particle diameter: 30 nm). The reaction mixture was purged with nitrogen and heated to 85° C. At 85° C. 5.0 g of feed 2 were added. After 5 min, feed 1 and feed 2 were added in 180 min.
Feed 1: 400.5 g deionized water, 18.5 g Dowfax 2A1, 20.8 g Lutensol TO 82, 6.9 g acrylic acid, 13.9 g acrylamide (50 wt % aqueous solution), 152.7 g α-methylene-γ-butyrolactone, 527.4 g isobutyl acrylate.
Feed 2: 19.8 g aqueous sodium persulfate solution (7 wt %).

The reaction mixture was post-polymerized at 85° C. for 30 min. Then feed 3 and feed 4 were added in 60 min.
Feed 3: 6.9 g aqueous t-butylhydroperoxide solution (10 wt %).
Feed 4: 6.2 g aqueous Rongalit C solution (10 wt %).

Then the reaction mixture was cooled down to ambient temperature and neutralized with sodium hydroxide to pH 8-9.
Tg (dried dispersion): 19° C.
Average particle diameter: 133 nm
Solid contents: 45.9 wt %

### Inventive Example E2

Binder Based on a Polymer with α-Methylene-γ-Butyrolactone, Isobutyl Acrylate and Methyl Methycrylate

A reactor equipped with stirrer, temperature control, nitrogen inlet and several injection possibilities was charged with 244.3 g deionized water, 27.3 g polystyrene seed dispersion (33 wt %, particle diameter: 30 nm). The reaction mixture was purged with nitrogen and heated to 85° C. At 85° C. 5.0 g of feed 2 were added. After 5 min, feed 1 and feed 2 were added in 180 min.
Feed 1: 400.5 g deionized water, 18.5 g Dowfax 2A1, 20.8 g Lutensol TO 82, 6.9 g acrylic acid, 13.9 g acrylamide (50 wt % aqueous solution), 107.6 g α-methylene-γ-butyrolactone, 100.6 g methyl methacrylate, 471.9 g isobutyl acrylate.
Feed 2: 19.8 g aqueous sodium persulfate solution (7 wt %).

The reaction mixture was post-polymerized at 85° C. for 30 min. Then feed 3 and feed 4 were added in 60 min.
Feed 3: 6.9 g aqueous t-butylhydroperoxide solution (10 wt %).
Feed 4: 6.2 g aqueous Rongalit C solution (10 wt %).

Then the reaction mixture was cooled down to ambient temperature and neutralized with sodium hydroxide to pH 8-9.
Tg (dried dispersion): 21° C.
Average particle diameter: 130 nm
Solid contents: 46.5 wt %

### Comparative Example C1

Binder Based on a Polymer with n-Butyl Acrylate and Methyl Methacrylate

A reactor equipped with stirrer, temperature control, nitrogen inlet and several injection possibilities was charged with 244.3 g deionized water, 27.3 g polystyrene seed dispersion (33 wt %, particle diameter: 30 nm). The reaction mixture was purged with nitrogen and heated to 85° C. At 85° C. 5.0 g of feed 2 were added. After 5 min, feed 1 and feed 2 were added in 180 min.
Feed 1: 400.5 g deionized water, 18.5 g Dowfax 2A1, 20.8 g Lutensol TO 82, 6.9 g acrylic acid, 13.9 g acrylamide (50 wt % aqueous solution), 346.4 g methyl methacrylate, 332.6 g n-butyl acrylate.
Feed 2: 19.8 g aqueous sodium persulfate solution (7 wt %).

The reaction mixture was post-polymerized at 85° C. for 30 min. Then feed 3 and feed 4 were added in 60 min.
Feed 3: 6.9 g aqueous t-butylhydroperoxide solution (10 wt %).
Feed 4: 6.2 g aqueous Rongalit C solution (10 wt %).

Then the reaction mixture was cooled down to ambient temperature and neutralized with sodium hydroxide to pH 8-9.
Tg (dried dispersion): 20° C.
Average particle diameter: 125 nm
Solid contents: 48.2 wt %

### 4.2 Formulation Examples

### Inventive Example E3

Formulation of semi-gloss paint with binder from Example E1

200.0 g Kronos 4311 pigment was mixed with 15.0 g water. At low stirring speed 1.75 g AMP-95 neutralizer (Angus Chemical Company), 5.0 g propylene glycol (Univar), 2.0 g Foamstar 2420 defoamer (BASF), 10.0 g Tamol 165 A dispersant (Dow) and 3.0 g Hydropalat WE 3320 wetting agent (BASF) were added. At high stirring speed 1.5 g Attagel 50 (BASF), 25.0 g Minex 10 (Sibelco) filler, 125.0 g Kronos 4311 pigment, 73.9 g water and 20.0 g Aquaflow NHS-310 (Ashland) non-ionic associative thickener were added and mixed for 30 min. The mixture was filtered through a 400 μm filter and then added to a combination of 527.0 g binder from Example E1, 25.0 g Ropaque Ultra E polymeric pigment (Dow) and 2.0 g Foamstar 2420 defoamer (BASF) and stirred for 5 min. 9.0 g Texanol coalescing agent (Eastman) and 9.0 g Optifilm 400 coalescing agent (Eastman) were added and mixed for 5 min. Then 2.0 g Proxel AQ biocide (Lonza), 3.0 g Polyphase 663 fungicide (Troy Corporation) and 3.5 g Rheolate CVS 10 non-ionic associative thickener (Elementis) were added and mixed for 5 min. Finally, 2.5 g Acrysol RM 895 non-ionic associative thickener (Dow) were added and the mixture was stirred for 30 min at medium speed.

### Inventive Example E4

Formulation of Semi-Gloss Paint with Binder from Example E2

200.0 g Kronos 4311 pigment was mixed with 15.0 g water. At low stirring speed 1.75 g AMP-95 neutralizer (Angus Chemical Company), 5.0 g propylene glycol (Univar), 2.0 g Foamstar 2420 defoamer (BASF), 10.0 g Tamol 165 A dispersant (Dow) and 3.0 g Hydropalat WE 3320 wetting agent (BASF) were added. At high stirring speed 1.5 g Attagel 50 (BASF), 25.0 g Minex 10 (Sibelco) filler, 125.0 g Kronos 4311 pigment, 81.4 g water and 20.0 g Aquaflow NHS-310 (Ashland) non-ionic associative thickener were added and mixed for 30 min. The mixture was filtered through a 400 μm filter and then added to a combination of 520.3 g binder from Example E2, 25.0 g Ropaque Ultra E polymeric pigment (Dow) and 2.0 g Foamstar 2420 defoamer (BASF) and stirred for 5 min. 9.0 g Texanol coalescing agent (Eastman) and 9.0 g Optifilm 400 coalescing agent (Eastman) were added and mixed for 5 min. Then 2.0 g Proxel AQ biocide (Lonza), 3.0 g Polyphase 663 fungicide (Troy Corporation) and 3.5 g Rheolate CVS 10 non-ionic associative thickener (Elementis) were added and mixed for 5 min. Finally, 1.7 g Acrysol RM 895 non-ionic associative thickener (Dow) were added and the mixture was stirred for 30 min at medium speed.

### Comparative Example C2

Formulation of Semi-Gloss Paint with Binder from Example C1

200.0 g Kronos 4311 pigment was mixed with 15.0 g water. At low stirring speed 1.75 g AMP-95 neutralizer (Angus Chemical Company), 5.0 g propylene glycol (Univar), 2.0 g Foamstar 2420 defoamer (BASF), 10.0 g Tamol 165 A dispersant (Dow) and 3.0 g Hydropalat WE 3320 wetting agent (BASF) were added. At high stirring speed 1.5 g Attagel 50 (BASF), 25.0 g Minex 10 (Sibelco) filler, 125.0 g Kronos 4311 pigment, 98.7 g water and 20.0 g Aquaflow NHS-310 (Ashland) non-ionic associative thickener were added and mixed for 30 min. The mixture was filtered through a 400 μm filter and then added to a combination of 502 g binder from Example C1, 25.0 g Ropaque Ultra E polymeric pigment (Dow) and 2.0 g Foamstar 2420 defoamer (BASF) and stirred for 5 min. 9.0 g Texanol coalescing agent (Eastman) and 9.0 g Optifilm 400 coalescing agent (Eastman) were added and mixed for 5 min. Then 2.0 g Proxel AQ biocide (Lonza), 3.0 g Polyphase 663 fungicide (Troy Corporation) and 3.0 g Rheolate CVS 10 non-ionic associative thickener (Elementis) were added and mixed for 5 min. Finally, 2.2 g Acrysol RM 895 non-ionic associative thickener (Dow) were added and the mixture was stirred for 30 min at medium speed.

### 4.3 Application Properties

The following application properties were determined.

### Gloss:

A coating film was prepared with a 3 mils drawdown bar on a Leneta 3B black and white sealed drawdown card. The film was dried at room temperature for 24 hours. Gloss was measured with a gloss meter at angles of 20°, 60° and 85°, respectively. The results were as follows:

| | Coatings from inventive examples E3 and E4 and comparative | | |
|---|---|---|---|
| | example C2 | | |
| | E3 | E4 | C2 |
| Gloss 20° | 8.0 | 10.8 | 8.0 |
| Gloss 60° | 41.5 | 46.5 | 41.5 |
| Gloss 85° | 76.7 | 78.7 | 77.3 |

Gloss was improved for E4 compared to C₂.

### High Shear Viscosity:

High shear viscosity measured according to ASTM D4287, 7 days after preparation. The results were as follows:

| | Coatings from inventive examples E3 and E4 and | | |
|---|---|---|---|
| | comparative example C2 | | |
| | E3 | E4 | C2 |
| High shear viscosity | 0.7 Poise | 0.7 Poise | 0.7 Poise |

Comparable results for all three samples.

### Opacity:

A coating film was prepared with a 3 mils drawdown bar on a Leneta 3B black and white sealed drawdown card. The film was dried at room temperature for 24 hours. The opacity was determined spectrophotometrically as the ratio of reflected light from the dried coating over the black portions and the white portions of the Leneta card. The opacity indicates the capability of the coating to hide the black surface. The results were as follows:

| | Coatings from inventive examples E3 and E4 and comparative | | |
|---|---|---|---|
| | example C2 | | |
| | E3 | E4 | C2 |
| Opacity | 97.5% | 97.7% | 97.2% |

Opacity was slightly improved for E3 and E4 compared to C2.

### Dry Alkyd Adhesion:

Dry alkyd adhesion was measured according to ASTM D3359. Evaluation was conducted after 7 days. The dry alkyd adhesion was rated with a scale of 0 to 5, wherein mark 0=complete film removed and mark 5=film not removed. The results were as follows:

| | Coatings from inventive examples E3 and E4 and | | |
|---|---|---|---|
| | comparative example C2 | | |
| | E3 | E4 | C2 |
| Dry alkyd adhesion | 4 | 3 | 0 |

Mark 0 = complete film removed, Mark 5 = film not removed

Dry alkyd adhesion was clearly improved for E3 and E4 compared to C₂.

### Wet Alkyd Adhesion:

Wet alkyd adhesion was measured according to ASTM D3359. Evaluation was conducted after 7 days. The wet alkyd adhesion was rated with a scale of 0 to 5, wherein mark 0=complete film removed and mark 5=film not removed. The results were as follows:

| | Coatings from inventive examples E3 and E4 and | | |
|---|---|---|---|
| | comparative example C2 | | |
| | E3 | E4 | C2 |
| Wet alkyd adhesion | 5 | 3 | 0 |

Mark 0 = complete film removed, Mark 5 = film not removed

Wet alkyd adhesion was clearly improved for E3 and E4 compared to C₂.

### Dry Intercoat Adhesion:

Dry intercoat adhesion was measured according to ASTM D3359. Evaluation was conducted after 7 days. The dry intercoat adhesion was rated with a scale of 0 to 5, wherein mark 0=complete film removed and mark 5=film not removed. The results were as follows:

| | Coatings from inventive examples E3 and E4 and | | |
|---|---|---|---|
| | comparative example C2 | | |
| | E3 | E4 | C2 |
| Dry intercoat adhesion | 5 | 5 | 5 |

Mark 0 = complete film removed, Mark 5 = film not removed

Comparable results for all three samples.

### Wet Intercoat Adhesion:

Wet intercoat adhesion was measured according to ASTM D3359. Evaluation was conducted after 7 days. The wet intercoat adhesion was rated with a scale of 0 to 5, wherein mark 0=complete film removed and mark 5=film not removed. The results were as follows:

| | Coatings from inventive examples E3 and E4 and | | |
|---|---|---|---|
| | comparative example C2 | | |
| | E3 | E4 | C2 |
| Wet intercoat | 5 | 5 | 5 |
| adhesion | | | |

Mark 0 = complete film removed, Mark 5 = film not removed

Comparable results for all three samples.

### König Pendulum Hardness:

König pendulum hardness was measured according to ASTM D4366 using coatings prepared on aluminum as substrate. Evaluation was conducted after 7 days. The results obtained, which are each the mean of three measurements, are given in the following table.

| | Coatings from inventive examples E3 and E4 and | | |
|---|---|---|---|
| | comparative example C2 | | |
| | E3 | E4 | C2 |
| Konig pendulum | 13.3 | 12.7 | 9.7 |
| hardness | oscillations | oscillations | oscillations |

Hardness was clearly improved for E3 and E4 compared to C2.

### Stain Removal:

Stain removal was measured according to ASTM D4828.

The results for the coatings from inventive examples E3 and E4 were comparable to those of the coating from comparative example C2 with regard to stains caused by pencil, lipstick, crayon, ballpen, red wine, ketchup, coffee, mustard (visual inspection).

### Dirt Pick-Up:

The mill glaze on yellow pine wood surface was scrubbed with water and dried overnight. The substrate was divided into sections depending on the number of samples to be tested. Using the appropriate brush, the test paint samples were applied at natural spread rate. The coatings were cured at room temperature for the period of 4 hours and 24 hours, respectively. Then, half of the coated area was covered with 2 inches of dry dirt (Arizona or Carpet soil). The panel was allowed to sit for 15 minutes, then tilted vertically and tapped to release dirt. The dirty area of each sample was lightly brushed (15 strokes).

Dirt pick-up was reduced for coatings from inventive examples E3 and E4 compared to the coating from comparative example C2 (visual evaluation).

1.-20. (canceled)

21. An aqueous polymer latex of a copolymer obtained by aqueous emulsion polymerisation of ethylenically unsaturated monomers M, which comprise
i. 5 to 40% by weight, based on the total amount of monomers M, of a monomer M1, which is a methylene-γ-butyrolactone;
ii. 20 to 95% by weight, based on the total amount of monomers M, of at least one monomer M2, which is selected from C₂-C₂₀-alkyl esters of acrylic acid, except for tert-butyl acrylate, and C₅-C₂₀-alkyl esters of methacrylic acid and mixtures thereof;
iii. 0 to 40% by weight, based on the total amount of monomers M, of at least one monomer M3, which is selected from tert.-butyl acrylate, C₁-C₄-alkyl esters of methacrylic acid, cyclopentyl methacrylate, cyclohexyl methacrylate, isobornyl methacrylate and monovinyl aromatic monomers and mixtures thereof,
iv. 0.05 to 5% by weight, based on the total amount of monomers M, of at least one monomer M4, which is selected from monoethylenically unsaturated monomers having an acidic group;
where the total amount of monomers M1 and M3 is in the range of 5 to 70% by weight, based on the total amount of ethylenically unsaturated monomers M, and where the total amount of monomers M1, M2 and M3 is at least 85% by weight, based on the total amount of ethylenically unsaturated monomers M.

22. The aqueous polymer latex of claim 21, wherein the monomer M1 is α-methylene-γ-butyrolactone.

23. The aqueous polymer latex of claim 21, wherein the methylene-γ-butyrolactone is of biological origin.

24. The aqueous polymer latex of claim 21, wherein the monomers M2 comprise isobutyl acrylate.

25. The aqueous polymer latex of claim 23, wherein at least the carbon atoms of the isobutyl group of isobutyl acrylate are of biological origin.

26. The aqueous polymer latex of claim 23, wherein the amount of isobutyl acrylate is in the range of 20 to 90% by weight, preferably in the range of 20 to 85% by weight, based on the total amount of monomers M.

27. The aqueous polymer latex of claim 21, wherein the monomer M3 comprises or is methyl methacrylate or where the monomer M3 comprises or is styrene.

28. The aqueous polymer latex of claim 21, where the monomers M further comprise at least one monoethylenically unsaturated, non-ionic monomer M5, which has a solubility in deionized water at 20° C. and 1 bar of at least 60 g/L.

29. The aqueous polymer latex of claim 21, where the monomers M do not comprise more than 1% by weight, based on the total amount of monomers M, of ethylenically unsaturated monomers M7 having at least 2 non-conjugated ethylenically unsaturated double bound.

30. The aqueous polymer latex of claim 21, where the monomers M consist of:
i. 5 to 40% by weight, based on the total amount of monomers M, of methylene-γ-butyrolactone, in particular α-methylene-γ-butyrolactone, as a monomer M1;
ii. 20 to 90% by weight, based on the total amount of monomers M, of at least one monomer M2, which comprises or is isobutyl acrylate;
iii. 0 to 40% by weight, based on the total amount of monomers M, of at least one monomer M3, which is selected from styrene, methyl methacrylate and combinations thereof;
iv. 0.05 to 5% by weight, based on the total amount of monomers M, of at least one monoethylenically unsaturated monomer M4, which is selected from monoethylenically unsaturated monomers having an acidic group;
v. 0 to 9.95% by weight, based on the total weight of the monomers M, of one or more non-ionic monomers M5 having a solubility in deionized water at 20° C. and 1 bar of at least 60 g/L.

31. The aqueous polymer latex of claim 21, where the polymer particles comprise a polymer phase, which has a glass transition temperature Tg in the range from −25 to +50° C.

32. The aqueous polymer latex of claim 21, where the polymer particles have a Z-average particle diameter in the range of 50 to 500 nm, as determined by dynamic light scattering according to the ISO 13321:1996 standard.

33. A process for producing an aqueous polymer latex of claim 21, which comprises performing an aqueous emulsion polymerisation of the monomers M.

34. The use of an aqueous polymer latex as defined in claim 21 as a binder in waterborne coating compositions.

35. A waterborne coating composition which contains
a) a binder polymer in the form of the aqueous polymer latex as defined in claim 21; and
b) at least one further ingredient which is conventionally used in waterborne coating compositions and which is not a binder.

36. The use of claim 34, where the waterborne coating composition does not contain more than 5% by weight of organic solvents.

37. The use of claim 34, where the waterborne coating composition has a pigment volume concentration of at least 5%.

38. The use or composition of claim 34, where the waterborne coating composition is a latex paint, in particular a latex paint for architectural coatings, a wood coating or wood staining composition or a latex paint for interior coatings.
